(19) United States
(12) Patent Application Publication
(10) Pub. No.: US 2026/0088036 A1
(43) Pub. Date: Mar. 26, 2026

(54) AUDIO RENDERING METHOD, SYSTEM, AND ELECTRONIC DEVICE

(71) Applicant: Douyin Vision Co., Ltd., Beijing (CN)

(72) Inventors: Shilei LIU, Beijing (CN); Chuanzeng Huang, Beijing (CN); Junjie Shi, Beijing (CN); Xuzhou Ye, Beijing (CN); Derong Liu, Beijing (CN); Zhengpu Zhang, Beijing (CN)

(21) Appl. No.: 19/405,160

(22) Filed: Dec. 1, 2025

Related U.S. Application Data
(63) Continuation of application No. PCT/CN2024/097045, filed on Jun. 3, 2024.

(30) Foreign Application Priority Data
Jun. 1, 2023 (WO) PCT/CN2023/097866

(51) Int. Cl. G10L 19/008

(52) U.S. Cl. CPC G10L 19/008

(57) ABSTRACT

An audio rendering method, a system, and an electronic device. An audio encoding device for audio rendering is configured to: acquire metadata related information associated with an audio signal, the metadata related information including spatial location information related to the audio signal; and on the basis of the metadata related information associated with the audio signal, perform spatial encoding on the audio signal to obtain an encoded audio signal.

### CROSS-REFERENCE TO RELATED APPLICATION(S)

The present application is a continuation application of PCT/CN2024/097045 filed Jun. 3, 2024, which is based on and claims the benefit of International Patent Application No. PCT/CN2023/097866, filed on Jun. 1, 2023, the aforementioned applications are hereby incorporated by reference in their entireties.

### TECHNICAL FIELD

The present disclosure relates to the technical field of audio signal processing, and in particular to an audio rendering method, a system, an electronic device, and a non-transitory computer-readable storage medium.

### BACKGROUND

Audio rendering refers to proper processing, playback, etc. of sound signals from a sound source to provide a user with a desired listening experience, especially an immersive experience, in the user application scenario. Ambisonics is an audio playback technical solution that may record, render, and restore characteristics of spatial sound using a limited number of channels, to provide a more realistic sense of presence to a listener.

### SUMMARY

According to some embodiments of the present disclosure, provided is an audio signal encoding device for audio rendering, configured to: acquire metadata related information associated with an audio signal, the metadata related information including spatial location information related to the audio signal; and spatially encode the audio signal based on the metadata related information associated with the audio signal, to obtain an encoded audio signal.

According to some embodiments of the present disclosure, provided is an audio signal encoding method for audio rendering, including: acquiring metadata related information associated with an audio signal, the metadata related information including spatial location information related to the audio signal; and spatially encoding the audio signal based on the metadata related information associated with the audio signal, to obtain an encoded audio signal.

According to some embodiments of the present disclosure, provided is an audio signal decoding device for audio rendering, configured to: acquire an encoded audio signal, where the encoded audio signal includes an encoded audio signal obtained by the audio signal encoding device according to embodiments of the present disclosure; and spatially decode the encoded audio signal to obtain a decoded audio signal for audio rendering.

According to some embodiments of the present disclosure, provided is an audio decoding method for audio rendering, including: acquiring an encoded audio signal, where the encoded audio signal includes an encoded audio signal obtained by the audio signal encoding device according to embodiments of the present disclosure; and spatially decoding the encoded audio signal to obtain a decoded audio signal for audio rendering.

According to some embodiments of the present disclosure, provided is an audio rendering system/audio rendering device, including: the audio signal encoding device according to embodiments of the present disclosure, and/or the audio signal decoding device according to embodiments of the present disclosure.

According to some embodiments of the present disclosure, provided is an audio rendering method, including: the audio signal encoding method according to some embodiments of the present disclosure, and/or the audio signal decoding method according to some embodiments of the present disclosure.

According to still some embodiments of the present disclosure, provided is a chip, including: at least one processor, and an interface, where the interface is configured to provide computer-executable instructions for the at least one processor, and the at least one processor is configured to execute the computer-executable instructions to implement the method of any one of the embodiments described in the present disclosure.

According to still some embodiments of the present disclosure, provided is a computer program, including: instructions/program codes, where the instructions/program codes, when executed by a processor, cause the processor to execute the method of any one of the embodiments described in the present disclosure.

According to still some embodiments of the present disclosure, provided is an electronic device, including: a memory; and a processor coupled to the memory, where the processor is configured to, based on instructions stored in the memory, execute the method of any one of the embodiments described in the present disclosure.

According to yet some embodiments of the present disclosure, provided is a computer-readable storage medium having a computer program stored thereon, where the program, when executed by a processor, implements the method of any one of the embodiments described in the present disclosure.

According to yet some embodiments of the present disclosure, provided is a computer program product including instructions that, when executed by a processor, implement the method of any one of the embodiments described in the present disclosure.

Other features of the present disclosure and advantages thereof will become apparent through the following detailed description of exemplary embodiments of the present disclosure with reference to the drawings.

### BRIEF DESCRIPTION OF THE DRAWINGS

The accompanying drawings described herein are used to provide a further understanding of the present disclosure and constitute a part of the present disclosure. The illustrative embodiments of the present disclosure and their descriptions are used to explain the present disclosure and do not constitute undue limitations on the present disclosure. In the attached drawings:

FIG. 1A shows a schematic diagram of some embodiments of an audio signal processing process;

FIG. 1B shows an exemplary block diagram of an audio rendering system according to some embodiments of the present disclosure;

FIG. 1C shows an exemplary flowchart of an audio rendering method according to some embodiments of the present disclosure;

FIG. 2 shows an exemplary schematic diagram of a core processing framework in an audio rendering scheme according to some embodiments of the present disclosure;

FIG. 3A shows an exemplary block diagram of an audio encoding device according to some embodiments of the present disclosure;

FIGS. 3B and 3C show exemplary implementations of audio encoding according to some embodiments of the present disclosure;

FIGS. 3D and 3E show exemplary flowcharts of an audio encoding method according to some embodiments of the present disclosure;

FIG. 4A shows an exemplary block diagram of an audio decoding device according to some embodiments of the present disclosure;

FIG. 4B shows an exemplary flowchart of an audio decoding method according to some embodiments of the present disclosure;

FIG. 5 shows a block diagram of some embodiments of an electronic device of the present disclosure;

FIG. 6 shows a block diagram of some other embodiments of the electronic device of the present disclosure; and

FIG. 7 shows a block diagram of some embodiments of a chip of the present disclosure.

It should be understood that for the convenience of description, the dimensions of various components shown in the drawings are not necessarily drawn according to the actual scale relationship. The same or similar reference numerals are used in the drawings to indicate the same or similar components. Therefore, once an item is defined in one figure, it may not be discussed further in subsequent figures.

### DETAILED DESCRIPTION OF EMBODIMENTS

In the following, the technical schemes according to embodiments of the disclosure will be clearly and completely described with reference to the attached drawings, obviously, the described embodiments are only a part of the embodiments of the disclosure, but not all the embodiments. The following description of at least one exemplary embodiment is merely illustrative in nature and is in no way intended to limit the present disclosure, its application or usage. Based on the embodiments in the present disclosure, all other embodiments obtained by those ordinary skilled in this field without creative work belong to the protection scope of this disclosure.

Unless otherwise specified, the relative arrangement of components and steps, numerical expressions and numerical values set forth in these embodiments do not limit the scope of the present disclosure. Techniques, methods and apparatuses known to those ordinary skilled in the relevant fields may not be discussed in detail, but in appropriate cases, they should be regarded as part of the authorized specification. In all examples shown and discussed herein, any specific values should be interpreted as being illustrative only, instead of being limitative. Therefore, other examples of exemplary embodiments may have different values.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect. Unless otherwise specified, the relative arrangement of components and steps, numerical expressions and numerical values set forth in these embodiments should be interpreted as merely exemplary, without limiting the scope of the present disclosure.

The term “including” and its variants used in this disclosure means an open term including at least the following elements/features, but not excluding other elements/features, that is, “including but not limited to”. In addition, the term “comprising” and its variants used in this disclosure mean an open term comprising at least the elements/features behind it, but not excluding other elements/features, that is, “comprising but not limited to”. Therefore, including is synonymous with comprising. The term “based on” means “at least partially based on”.

Reference throughout this specification to “one embodiment”, “some embodiments” or “embodiments” means that a particular feature, structure or characteristic described in connection with an embodiment also can be included in at least one embodiment of the present invention. For example, the term “one embodiment” means “at least one embodiment”; the term “another embodiment” means “at least one other embodiment”; the term “some embodiments” means “at least some embodiments”. Moreover, the appearances of the phrases “in one embodiment”, “in some embodiments” or “in an embodiment” in various places throughout the specification do not necessarily all refer to the same embodiment, but they may also refer to the same embodiment.

It should be noted that the concepts of “first” and “second” mentioned in this disclosure are only used to distinguish different apparatuses, modules or units, and are not used to limit the order or interdependence of the functions performed by these apparatuses, modules or units. Unless otherwise specified, the concepts of “first” and “second” are not intended to imply that the objects so described must be in a given order in time, space, ranking or in any other way.

It should be noted that the modifications of “a” and “a plurality” mentioned in this disclosure are schematic rather than limiting, and those skilled in the art should understand that unless the context clearly indicates, otherwise, they should be understood as “one or more”.

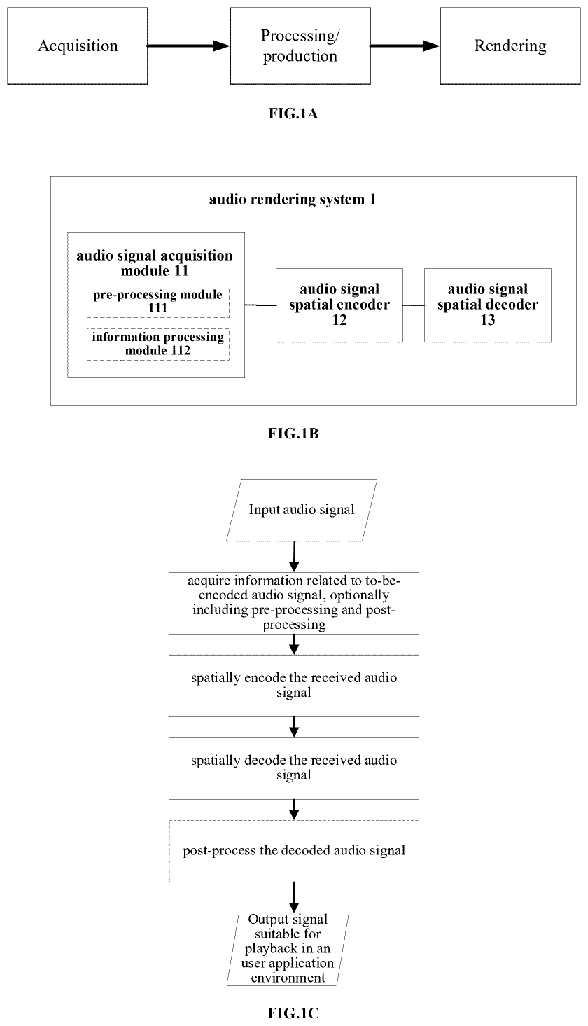

FIG. 1A shows some conceptual schematic diagrams of audio signal processing, especially a process/system from acquisition to rendering. As shown in FIG. 1A, in the system, an audio signal, after having been acquired, is processed or produced, and then the processed/produced audio signal is distributed to a rendering end for rendering, the audio signal is processed at an audio rendering end/playback end to be played back/presented to a user. In particular, the audio signal is rendered and presented to the user with a desired effect to satisfy user experience. It should be noted that such an audio signal processing flow may be applied to various application scenarios, especially virtual reality audio content expression.

Currently, there are a variety of audio application scenarios, such as an audio rendering scenario, such as an XR virtual scenario, which may refer to a highly realistic virtual scenario created by at least one of virtual reality (VR), augmented reality (AR), or mixed reality (MR) technologies. Especially, Ambisonics refers to a highly anticipated audio transmission mode in the XR scenario. The Ambisonics technology may usually be used in audio rendering/playback. Ambisonics corresponds to a mathematical representation of a three-dimensional sound field. Different from the traditional channel-based or object-based transmission modes, Ambisonics supports head rotation in any direction, and is especially suitable for representation of a three-dimensional rotatable sound field. Meanwhile, it is also a standard mathematical encoding/decoding solving, which has advantages of small theoretical error and orthogonal basic groups.

Virtual source imaging or sound encoding in traditional Ambisonics mainly focuses on encoding based on far-field assumption, and ignores the near-field effect of a source at a finite distance, that is, it is considered that sound sources are all located in a region far from the head, and thus only rendering and encoding of two spatial dimensions (θ, φ) related to a direction are mainly concerned, without considering encoding of distance. The core logic is that it is assumed that the sound source is far enough, so that it is reasonable to ignore the change in hearing caused by the distance change; therefore, the distance of a sound image does not bring a change in hearing. This method is applicable to a sound scenario such as a traditional cinema, because it has a far sound image position, and thus the influence of ignoring the change in the distance of the sound image on hearing is not too obvious. However, for the scenario of XR devices, since there are many sound images that are close to the human ears, and even distance changes, it is necessary to pay attention to the change in the distance of the sound images.

In some traditional implementations and operations, the sense of distance is enhanced by using low-frequency characteristics. Some strategies are to enhance the low frequency to make the human ears feel that the sound is closer, which is based on certain grounds. The main reason is that high-frequency sound is attenuated more than low-frequency sound, and therefore when the sound source is far away, the high frequency is generally attenuated more seriously, that is, enhancing the low frequency makes the perceived distance closer. In some actual use processes, the sense of distance is enhanced by using reverberation. Some schemes enhance the reverberation of sound to enhance the sense of distance in hearing. This scheme mainly uses the characteristic that the perception of reverberation in psychoacoustics makes people feel spacious, so that the listener has a sense of distance. This scheme mainly uses a dislocation in psychoacoustics, instead of rendering the distance in a real sense.

In view of this, the present disclosure proposes an improved audio processing, especially an improved audio encoding/decoding, which enables encoding in three dimensions (such as, (x, y, z), (r, θ, φ), and other three dimensions or other N dimensions known or applicable in the art, etc.) in a 3D space to be implemented, thereby enhancing the rendered sense of distance, and additionally or optionally, enabling sound field restoration to be implemented in a larger range. In the context of the present disclosure, encoding/decoding generally refers to a process of converting a normal audio signal (for example, a normal time-domain signal) into an Ambisonic signal and vice versa, which may be referred to as Ambisonic encoding/decoding, different from the traditional encoding/decoding for transmitting compressed audio.

In particular, the present disclosure proposes to introduce near-field compensation in the encoding stage, for example, encoding based on the distance, including but not limited to designing a distance encoding filter, so that a feasible Ambisonic format may be obtained, thereby making the information carried by the Ambisonics sound field more complete, and providing more accurate hearing to the listener.

In addition, the present disclosure further proposes improved low-frequency processing, in which a low-frequency increase amplitude is accurately calculated, which is more accurate, and enables the listener to perceive the distance more accurately.

Still in addition, the present disclosure further proposes reasonable phase adjustment, which reasonably presents the time-delay problem of sound wave propagation, thereby bringing a more realistic effect.

An exemplary implementation according to embodiments of the present disclosure will be described below by using an Ambisonics audio signal as an example. It should be noted that the concept and scheme of the present disclosure may also be appropriately applied to other types of audio signals. Audio rendering according to embodiments of the present disclosure will be described in detail with reference to the drawings.

FIG. 1B shows a block diagram of some embodiments of an audio rendering system according to embodiments of the present disclosure. The audio rendering system 1 includes an audio signal acquisition module 11 configured to acquire an input audio signal, an audio signal encoder 12 configured to encode the input audio signal into an audio signal in a specific spatial format; and an audio signal decoder 13 configured to spatially decode the encoded audio signal in the specific spatial format to obtain a decoded audio signal for audio rendering, so that audio may be presented/played back to a user based on the spatially decoded audio signal.

In some embodiments, the audio signal in the specific spatial format may be any appropriate format, as long as it may be used for playback in a user playback environment. In some embodiments, the input audio may be appropriately processed, for example, encoded, subjected to format conversion, etc., to obtain the audio signal in the specific spatial format. In some embodiments, in the case where the input audio signal may be used to obtain audio signals in two or more audio content formats, the obtained audio signals in the specific spatial format have a common format, that is, the audio signals in various audio content formats all obtain the audio signals in the same format for playback. As an example, the audio signal in the specific spatial format is an Ambisonics audio signal, or the audio signal in the specific spatial format is any one of First Order Ambisonics (FOA), Higher Order Ambisonics (HOA), and Mixed-order Ambisonics (MOA).

According to the embodiments of the present disclosure, the input audio signal may be in various formats, and the audio signal in the specific spatial format may be appropriately obtained based on the format of the input audio signal. In some embodiments, the input audio signal may be in a distributed spatial audio exchange format, which may be obtained from various acquired audio content formats. Therefore, spatial audio processing, especially encoding, is performed on such an input audio signal to obtain the audio signal having the specific spatial format. In particular, in some embodiments, the spatial audio processing may include appropriate processing performed on the input audio, especially including parsing, format conversion, information processing, encoding, etc., to obtain the audio signal in the specific spatial format. In some other embodiments, the audio signal in the specific spatial format may be directly obtained from the input audio signal, without performing at least some of the spatial audio processing. In some embodiments, the input audio signal may contain or be directly a signal in a specific audio content format, for example, a specific audio representation signal, so that encoding may be directly performed on the audio signal, thereby obtaining the audio signal in the specific spatial format. In still some other embodiments, the input audio signal may further include an audio signal that is directly in the specific spatial format, and such an audio signal will be directly transmitted/passed through to the decoding side, without going through an intermediate processing stage.

In some embodiments, the input audio signal may include an original input signal, for example, an input signal in a different format, which is applied to different application scenarios. In some embodiments, a pre-processing module may be included. In view of different application scenarios and input formats, the pre-processing module may be configured to be compatible with inputs in different formats. In some embodiments, the pre-processing module is configured to obtain, from the input audio signal, at least one of an audio signal having an audio content format compatible with the audio rendering system or metadata information associated with the audio signal, so that the audio signal in the specific spatial format may be obtained based on the audio signal having the audio content format compatible with the audio rendering system. The pre-processing module may be included in the audio signal acquisition module 11, as shown in FIG. 1 as the pre-processing module 111. In some other embodiments, the input signal may be directly an audio signal having an audio content format compatible with the audio rendering system. In this case, the pre-processing operation may be processed by another device in the system, and the pre-processing module may be located outside the audio signal acquisition module of the present disclosure, or even outside the audio processing system. In some embodiments, the audio signal acquisition module may obtain an audio signal in a specific audio content format and metadata information associated with the audio signal by parsing the input signal, or receive the audio signal in the specific audio content format and the metadata information associated with the audio signal that are directly input.

According to the embodiments of the present disclosure, audio signal encoding may be performed based on the metadata related information. The metadata related information is associated with the input audio signal, and may be acquired together with the audio signal, or may be extracted from the input audio signal. As an example, the metadata related information may be acquired by the acquisition module, or acquired by another device/module and provided to the audio signal encoder. In some embodiments, the metadata related information may be in various forms, and may contain various information, such as a spatial attribute, a channel attribute, and so on. The metadata related information may usually depend on a signal type of the audio signal, and may particularly correspond to the signal representation of the signal. For example, for an object-based signal representation, the metadata information may be related to an attribute (especially a spatial attribute) of the audio object; for a scene-based signal representation, the metadata information may be related to an attribute of the scenario; and for a channel-based signal representation, the metadata information may be related to an attribute of the channel. As an example, the spatial location information of the sound source may be included in the metadata related information.

In some embodiments, the acquisition module 11 may further include an audio information processing module 112, configured to extract an audio parameter for an audio signal in the specific audio content format based on metadata associated with the audio signal in the specific audio content format, so that the audio signal encoding module may be further configured to spatially encode the audio signal in the specific audio content format based on at least one of the metadata associated with the audio signal or the audio parameter. As an example, the audio information processing module may be referred to as a scenario information processor, which may provide the audio parameter extracted based on the metadata to the audio signal encoding module for encoding. The audio information processing module is not necessary for the audio rendering of the present disclosure. For example, the information processing function may be not performed, or the audio information processing module may be located outside the audio rendering system, or the audio information processing module may be included in another module, such as the audio signal acquisition module or the audio signal encoding module, or the function of the audio information processing module may be implemented by another module. Therefore, the audio information processing module is indicated by a dotted line in the figure.

In some embodiments, additionally or optionally, the audio rendering system may include a signal adjustment module configured to perform signal processing on the decoded audio signal. The signal processing performed by the signal adjustment module may be referred to as a kind of signal post-processing, especially post-processing performed on the decoded audio signal before playback by a playback device. Therefore, the signal adjustment module may also be referred to as a signal post-processing module. In particular, the signal adjustment module may be configured to adjust the decoded audio signal based on a characteristic of the playback device in the user application scenario, so as to provide a more appropriate acoustic experience when the adjusted audio signal is rendered by the audio rendering device. It should be noted that the audio signal adjustment module is not necessary for the audio rendering of the present disclosure. For example, the signal adjustment function may be not performed, or the audio signal adjustment module may be located outside the audio rendering system, or the audio signal adjustment module may be included in another module, such as the audio signal decoding module, or the function of the audio signal adjustment module may be implemented by the decoding module. Therefore, the audio signal adjustment module is indicated by a dotted line in the figure.

Additionally, the audio rendering system 1 may further include or be connected to an audio input port configured to receive an input audio signal, the audio signal may be distributed and transmitted to the audio rendering system in the audio system, as described above, or may be directly input by the user at the user side or the consumer side, which will be described later. Additionally, the audio rendering system 1 may further include or be connected to an output device, such as an audio presentation device or an audio playback device, which may present the spatially decoded audio signal to the user. According to some embodiments of the present disclosure, the audio presentation device or the audio playback device according to the embodiments of the present disclosure may be any appropriate audio device, such as a speaker, a speaker array, a headphone, and any other appropriate device that may present the audio signal to the user.

FIG. 1C shows a flowchart of some embodiments of an audio rendering method according to the present disclosure. Each step/process in the method may be performed as described above, for example, performed by a corresponding module. Although not shown, the audio rendering method according to the present disclosure may further include other steps to implement the processing/operation in the pre-processing, audio information processing, audio signal spatial encoding, etc. described above, which will not be described in detail herein. It should be noted that the audio rendering method and the steps therein according to the present disclosure may be performed by any appropriate device, such as a processor, an integrated circuit, a chip, etc., for example, by the audio rendering system and the modules therein described above. The method may also be implemented in a computer program, instructions, a computer program medium, a computer program product, etc.

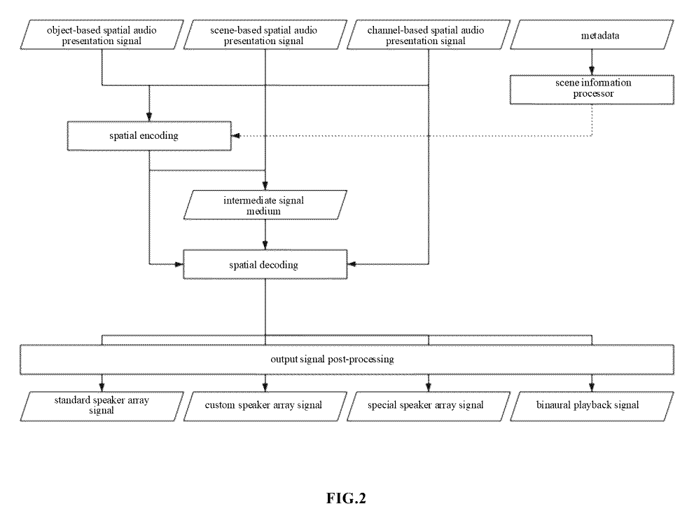

An audio rendering process of some embodiments of the present disclosure will be outlined below with reference to FIG. 2, which shows an exemplary schematic diagram of a core processing framework in an audio rendering scheme according to some embodiments of the present disclosure. Generally, the encoding and decoding process of the spatial audio signal according to the present disclosure may be reflected in the framework shown in FIG. 2. The audio encoding scheme involved in the present disclosure, especially the encoding related to distance, belongs to a sub-step of spatial encoding or a sub-module of the spatial encoding module, which is especially used for an object-based spatial sound encoding mode. The audio decoding scheme involved in the present disclosure, especially the decoding related to distance, belongs to a sub-step of spatial decoding or a sub-module of the spatial decoding module, which is especially used for an object-based spatial sound decoding mode. Unless otherwise specified, the encoding and decoding of the audio signal mentioned here and below refer to the Ambisonics encoding and decoding as described above.

As an example, the audio rendering system mainly includes a rendering metadata system and a core rendering system. The metadata system includes control information that describes audio content and a rendering technology, such as indicating whether an audio input form is single-channel, dual-channel, multi-channel, or object or sound field HOA, dynamic spatial location information of a sound source and a listener, or rendering acoustic environment information such as a shape, a size and a wall material of a room, and so on. The core rendering system performs rendering of a corresponding playback device and environment based on different audio signal representation forms and metadata.

First, the input audio signal is received. In particular, the input audio signal may be processed according to the format of the input audio signal, for example, parsed or directly transmitted. On one hand, when the input audio signal is an input signal having any spatial audio exchange format, signal parsing may be performed on the input audio signal to obtain an audio signal having a specific spatial audio representation, such as an object-based spatial audio representation signal, a scene-based spatial audio representation signal, a channel-based spatial audio representation signal, and associated metadata, and then the parsing result is passed to a subsequent processing stage. On the other hand, when the input audio signal is directly an audio signal having a specific spatial audio representation, the input audio signal is directly passed to the subsequent processing stage without parsing. For example, such an audio signal may be directly transmitted to an audio encoding stage, and may be, for example, an object-based audio representation signal, a scene-based audio representation signal, or a narrative channel audio track that needs to be encoded in a channel-based audio representation signal. Even in the case where the audio signal having the specific spatial representation is a type/format that does not need to be encoded, for example, a non-narrative channel audio track in a parsed channel-based audio representation or a narrative channel audio track that does not need to be encoded, the audio signal may be directly transmitted to an audio decoding stage.

Then, information processing may be performed based on the acquired metadata to extract an audio parameter related to each audio signal. Such an audio parameter may also be included in the metadata information. The information processing here may be performed for either the parsed audio signal or the directly transmitted audio signal. Certainly, as described above, such information processing is optional and not necessarily performed.

Next, signal encoding is performed for the audio signal having the specific spatial audio representation. On one hand, signal encoding may be performed on the audio signal having the specific spatial audio representation based on the metadata information. The obtained encoded audio signal is either directly transmitted to a subsequent audio decoding stage, or is used for obtaining an intermediate signal which is then transmitted to the subsequent audio decoding stage. On the other hand, in the case where the audio signal having the specific spatial audio representation does not need to be encoded, such an audio signal may even be directly transmitted to the audio decoding stage.

Then, in the audio decoding stage, the received audio signal may be decoded to obtain an audio signal suitable for playback in the user application scenario as an output signal. Such an output signal may be presented to the user through an audio playback device in the user application scenario, for example, an audio playback environment.

It should be noted that the elements of the audio rendering system as described above are only logical modules divided according to the specific functions implemented, and are not used to limit the specific implementations, for example, the elements may be implemented by software, hardware, or a combination of software and hardware. In an actual implementation, the units described above may be implemented as independent physical entities, or may be implemented by a single entity (for example, a processor (CPU or DSP, etc.), an integrated circuit, etc.). For example, the encoder, the decoder, etc. may use a chip (such as an integrated circuit module including a single wafer), a hardware component, or a complete product. In addition, the elements shown by dotted lines in the figure indicate that these elements may exist but do not need to actually exist, and the operations/functions implemented by them may be implemented by the processing circuit itself. In addition, the modules described above are indicated by dotted lines in the figure, indicating that these units may not actually exist, and the operations/functions implemented by them may be implemented by other modules containing these modules or the system and apparatus themselves. For example, at least one of the pre-processing module 111 or the information processing module 112 shown in FIG. 1A may be located outside the acquisition module 11 but exist in the audio rendering system 1, for example, between the acquisition module 11 and the encoder 12, so that the input audio signal can be processed sequentially to obtain the audio signal to be processed by the decoder. It may even be located outside the audio rendering system.

In addition, optionally, the audio rendering system 1 may further include other components not shown, such as an interface, a memory, a communication unit, and the like. As an example, the interface and/or the communication unit may be configured to receive an input audio signal to be rendered, and may also output a final audio signal to a playback device in a playback environment for playback. In an example, the communication unit may be implemented in an appropriate manner known in the art, for example, including communication components such as an antenna array and/or a radio frequency link, various types of interfaces, communication units, and the like. Details will not be described here. In addition, the device may further include other components not shown, such as a radio frequency link, a baseband processing unit, a network interface, a processor, and a controller. Details will not be described here. As an example, the memory may store various information generated in operations by the modules included in the system and the device, programs and data for operations, data to be sent by the communication unit, etc., for example, various data, information, programs, etc. used in the audio rendering and/or generated during the audio rendering process. The memory may be a volatile memory and/or a non-volatile memory. For example, the memory may include but be not limited to a random-access memory (RAM), a dynamic random-access memory (DRAM), a static random access memory (SRAM), a read-only memory (ROM), and a flash memory. Certainly, the memory may also be located outside the device.

An exemplary implementation of audio signal encoding and decoding according to the embodiments of the present disclosure will be specifically described below with reference to the drawings. In embodiments of the present disclosure, audio spatial location information is considered in the encoding and decoding processing of the audio signal, in particular, the audio spatial location information may be included in or be equivalent to spatial orientation information, and in particular includes spatial distance information, so that the accuracy of spatial encoding and decoding may be further improved, and the audio rendering effect may be improved.

In some embodiments, an audio encoding scheme for audio rendering is proposed, where, for an input audio signal in a specific audio content format, the audio signal in the specific audio content format may be spatially encoded based on metadata related information associated with the audio signal in the specific audio content format, to obtain an encoded audio signal. In particular, the metadata related information may include audio spatial location information, which may refer to spatial location information related to the audio signal, for example, including but not limited to spatial location information of the audio signal itself, spatial location information of a sound source of the audio signal, spatial propagation information of the audio signal, spatial location information of a listener, and related information of a listening environment, etc. As an example, the spatial location information of the sound source includes at least one of a distance, a vertical plane angle, or a horizontal plane angle of the sound source, or the like. In particular, the spatial location information of the object-based audio representation signal includes at least one of: location information of each audio element in the audio representation signal in a coordinate system, distance information of each audio element, various angle information, or relative location information of the sound source related to the audio signal with respect to the listener.

According to some embodiments of the present disclosure, the audio signal in the specific audio content format may include at least one of an object-based spatial audio representation signal, a channel-based spatial audio representation signal, a scene-based spatial audio representation signal, etc., and the encoded audio signal in the specific spatial format may include an Ambisonics audio signal.

According to some embodiments of the present disclosure, an audio signal encoder for audio rendering (which may also be referred to as an audio signal encoding device, an audio signal encoding module, etc.) may be configured to acquire metadata related information associated with an audio signal, the metadata related information including spatial location information related to the audio signal; and spatially encode the audio signal based on the metadata related information associated with the audio signal, to obtain an encoded audio signal. In the embodiments of the present disclosure, the audio signal encoder may be implemented in various appropriate manners.

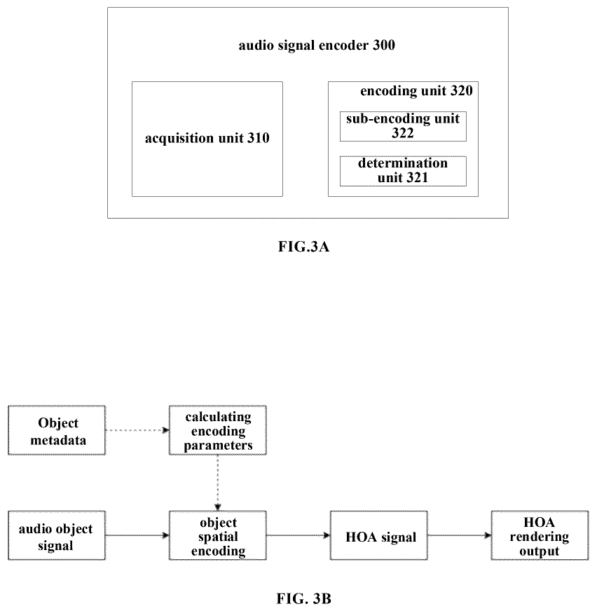

FIG. 3A shows an exemplary block diagram of an audio signal encoder (which may also be referred to as an audio signal encoding device, an audio signal encoding module, etc.) for audio rendering according to some embodiments of the present disclosure. The audio signal encoder 300 shown in FIG. 3A includes an acquisition unit 310, configured to acquire metadata related information associated with an audio signal, the metadata related information including spatial location information related to the audio signal; and an encoding unit 320 configured to spatially encode the audio signal based on the metadata related information associated with the audio signal, to obtain an encoded audio signal. Here, the audio signal may be an audio signal in a specific audio content format, and the spatial location information related to the audio signal may especially include spatial location information of a sound source of the audio signal, and in particular may include distance information related to the audio signal. In some embodiments, the encoding unit 320 may include a determination unit 321 configured to determine an encoding parameter based on the metadata related information; and a sub-encoding unit 322 configured to encode the audio signal into an encoded audio signal in a specific spatial format based on the encoding parameter. Certainly, the determination unit and the sub-encoding unit may not exist, and the functions thereof are implemented by the encoding unit itself.

According to embodiments of the present disclosure, the acquisition unit may be implemented in various appropriate manners, and may receive various appropriate audio signals. In some embodiments, the acquisition unit may directly receive the audio signal in the specific audio content format. As an example, the acquisition unit may be a specific input port/input device. In some other embodiments, the acquisition unit may further parse or process the input audio signal to acquire the audio signal in the specific audio content format, which is similar to the pre-processing described above and will not be described in detail here.

According to some embodiments of the present disclosure, the acquired audio signal in the specific audio content format may be referred to as an audio signal to be encoded. As an example, the acquired audio signal may be a non-directly transmitted/passed audio signal, may have various audio content formats or audio representation manners, such as at least one of the three representations of audio signals as described above, or another appropriate audio signal. As an example, such an audio signal may be, for example, the object-based audio representation signal or the scene-based audio representation signal as described above, or may be a signal that has been pre-specified to be encoded for a specific application scenario, for example, a narrative channel audio track in the channel-based audio representation signal as described above. In particular, the acquired audio signal may be directly input, as described above, a signal that does not need signal parsing, or may be extracted/parsed from the input audio signal, for example, an audio signal that needs audio encoding and can be obtained through the signal parsing module as described above. As an example, in particular, the audio signal in the specific audio content format is an object-based audio representation signal, and the audio signal encoding module is configured to spatially encode the object-based audio representation signal based on spatial location information related to the object-based audio representation signal. In particular, encoding may be performed by matrix multiplication.

In some examples, the acquisition unit may be implemented to receive only the audio signal to be encoded, for example, the audio signal to be encoded that is directly input or obtained from the audio signal parsing module, as described above.

In some other embodiments, the audio signal encoder may be implemented to receive an audio signal or an audio representation signal in various audio content formats. In this way, in an implementation, it may be determined whether the audio signal received by the audio signal encoder is an audio signal that needs to be encoded, and in the case where it is determined that the audio signal needs to be encoded, the audio signal is sent to the acquisition unit and the encoding unit; while in the case where it is determined that the audio signal does not need to be encoded, the audio signal is directly sent to the decoding module without audio encoding. Such a determination operation may be implemented by a separate unit. In addition to the acquisition unit and the encoding unit, for example, the audio signal encoder may further include a determination unit to implement the determination operation. Alternatively, such a determination operation may be performed by the acquisition unit itself. As an example, the acquisition unit may include a determination subunit to perform the determination operation described above. In some embodiments, the determination may be performed in various appropriate manners, for example, by comparison with reference to an audio content format or an audio signal representation manner of the audio. When the format or representation manner of the input audio signal matches the format or representation manner of the audio signal that needs to be encoded, it is determined that the input audio signal needs to be encoded. For another example, the determination unit may further receive other reference information, such as application scenario information, a rule pre-specified for the specific application scenario, etc., and may perform determination based on the reference information. As described above, when the rule pre-specified for the specific application scenario is known, the audio signal that needs to be encoded may be selected from audio signals according to the rule. For another example, the determination unit may further acquire a signal type related identifier, and determine whether the signal needs to be encoded according to the signal type related identifier. The identifier may be in various appropriate forms, such as a signal type identifier, and any other appropriate indication information that may indicate the signal type.

In yet another example, the acquisition unit may not even be included in the audio signal encoder, but only provides the acquired audio signal and metadata related information to a calculation unit for subsequent calculation and encoding.

According to the embodiments of the present disclosure, the metadata related information associated with the audio signal may include at least one of: metadata associated with the audio signal, or an audio parameter of the audio signal that is obtained based on the metadata. In some embodiments, the metadata related information may include metadata related to the audio signal, such as metadata acquired together with the audio signal, for example, directly input or acquired through signal parsing, as described above. In some embodiments, the metadata related information may be directly input when the audio signal is input, for example, in the case where the input audio signal may be directly input through an API without the need for the audio signal parsing described above, the metadata related information may be input together with the audio signal when the audio signal is input, or may be input separately from the audio signal. In some other embodiments, the metadata related information may further include the audio parameter of the audio signal that is obtained based on the metadata, as described above for the operation of the information processing module. In particular, the metadata related information may be obtained through signal parsing processing. In some examples, the metadata related information may include metadata associated with the specific audio representation signal that is obtained when the distributed input signal having the spatial audio exchange format is parsed through the signal parsing processing as described above. In some other embodiments, the parsed audio signal metadata or the directly input metadata may be further processed, such as information processing, so that an appropriate audio parameter/information may be obtained for use as the metadata information in audio encoding. The information processing may be referred to as scene information processing, and in the information processing, processing may be performed based on the metadata associated with the audio signal to obtain an appropriate audio parameter/information.

FIG. 3B shows an exemplary implementation of spatial encoding according to some embodiments of the present disclosure. First, for object-based spatial encoding, an object-based spatial audio representation signal may be acquired, and metadata of an object may also be acquired. The metadata may include at least spatial location information related to an audio object, such as spatial location information (such as spatial distance information) of a sound source of the audio object. Then, an encoding parameter is calculated based on the metadata of the object, and an audio object HOA signal is encoded based on the encoding parameter from the object-based spatial audio representation signal for use in audio rendering.

According to some embodiments of the present disclosure, the encoding parameter may include a parameter related to an encoding coefficient, which may be represented as an encoding coefficient matrix, especially a distance-related encoding coefficient matrix, and the calculation unit may be further configured to construct the distance-related encoding coefficient matrix based on the spatial location information of the sound source, especially based on the distance information of the sound source, and the encoding unit may be further configured to encode the audio signal into the encoded audio signal in the specific spatial format based on the distance-related encoding coefficient matrix. Certainly, it should be pointed out that the encoding parameter may further include an encoding coefficient related to another directional component, such as a direction-related encoding coefficient matrix. For the sake of simplicity, the encoding coefficient matrix may also be simply referred to as an encoding matrix.

In some embodiments, the encoding parameter may include an encoding parameter corresponding to an attribute of the audio signal. In particular, the attribute of the audio signal may relate to a channel of the encoded audio signal in the specific spatial format, and the encoding parameter may include an encoding parameter corresponding to the channel, especially a distance-related encoding coefficient matrix corresponding to the channel of the encoded audio signal in the specific spatial format. Therefore, the calculation unit may be further configured to calculate the corresponding distance-related encoding coefficient matrix based on the channel of the encoded audio signal in the specific spatial format.

In some embodiments, the encoding coefficient matrix may be related to a directional attribute of the audio signal, and in particular, may be further calculated based on a directional characteristic of the sound source. In some embodiments, the calculation unit may be further configured to calculate the encoding coefficient matrix based on the directional characteristic of the sound source. In some embodiments, the encoding coefficient matrix may also be calculated based on both the directional characteristic and a distance characteristic of the sound source, for example, based on the directional characteristic of the sound source and the distance-related encoding coefficient matrix. It should be understood that the above construction/calculation of the encoding matrix may also be implemented before the encoding step, or may be performed during the encoding step.

In some embodiments of the present disclosure, the encoding of the audio signal may be performed in various appropriate manners, in particular, by various appropriate matrix multiplications. In some embodiments, the encoding unit may be further configured to perform encoding by multiplying or convolving the audio signal with the encoding matrix.

As an example, the encoding of the audio signal based on the spatial location information according to the embodiments of the present disclosure may include: acquiring location information of the sound source of the audio signal, including distance information and directional information, wherein the directional information may include a vertical plane angel, a horizontal plane angle, such as an elevation angle, an azimuth angle, etc.; calculating different distance-related encoding coefficient matrices according to Ambisonics channels with different orders, in particular, calculating a corresponding distance-related encoding coefficient matrix for each channel; and performing calculation of an encoding matrix according to the directional information of the sound source, for example, characteristics in different directions, and finally multiplying or convolving the signal with the encoding matrix for encoding.

FIG. 3C shows an exemplary implementation of a spatial encoding method according to an embodiment of the present disclosure. The input audio signal S is encoded based on input location information, in particular, distance encoding is performed based on distance information in the input location information to construct a distance encoding matrix, and angle encoding is also performed based on angle information in the input location information, so as to obtain a location encoding matrix, which may be obtained based on a combination of the distance encoding and the angle encoding.

The encoding of the audio signal based on the spatial location information according to the embodiments of the present disclosure may be implemented in various appropriate manners. In some exemplary implementations, the encoding of the audio signal based on the spatial location information may be performed by solving an equation. In some embodiments, an acoustic equation may be constructed in a specific coordinate system, the acoustic equation is constructed for the audio signal based on or considering the spatial location information, and includes or may derive a sub-equation or term related to the distance information of the sound source, and the acoustic equation is solved by using a specific function, in particular, the sub-equation or term related to the distance information of the sound source in the acoustic equation may be solved by using the specific function, thereby implementing the encoding of the audio signal based on the distance information of the sound source. Here, equivalently, a solution of the equation, especially a correlation coefficient in the equation result, may correspond to the encoding parameter for audio encoding. In some embodiments, the encoding parameter may be generated by solving a sound wave equation based on the specific function, and in particular, may be generated by solving the sub-equation or term related to the distance information of the sound source in the acoustic equation based on the specific function. In this way, by considering the distance information of the sound source, the obtained encoding matrix and then the encoding result are more accurate and comprehensive, and may better reflect the spatial distance characteristic in the audio rendering environment, so that the rendering or playback effect is more realistic, which is especially suitable for an application scenario that considers the near-field effect, such as an XR scenario.

Additionally, the solving of the equation may further involve the solving of a sub-equation related to the directional information that may be included in or derived from the acoustic equation. In this way, it may be combined with the solving of the sub-equation related to the distance information of the sound source, for example, performed together in the process of solving the equation. In this way, by considering the combination of the distance information and the directional information of the sound source, the audio signal may be encoded more comprehensively and accurately.

In some embodiments, the specific coordinate system may be a spherical coordinate, and the specific equation may be a specific sound wave equation for the audio signal in the spherical coordinate. In particular, the specific equation is an equation for a sound pressure signal, and in the spherical coordinate, the sound pressure signal may usually be represented by a spatial distance, an elevation angle, an azimuth angle, etc., and the equation may be constructed accordingly.

In some examples, in the solving process, variable separation may be used to obtain a sub-equation related to the spatial distance from a specific sound wave equation, and the solution of the sub-equation related to the spatial distance may be obtained based on a specific function, thereby implementing the encoding of the audio signal. Such variable separation may be implemented based on Laplace transform, and may also be implemented by other appropriate methods, algorithms, etc. As an example, the equation construction and transformation used in the Ambisonics technology in the art may be adopted, which will not be described in detail here.

In some embodiments, the specific function may include a function corresponding to the acoustic equation or the sound wave equation, for example, the specific function may include a function of the same type as the acoustic equation or the sound wave equation, or other compatible/applicable functions. In particular, the specific function may include a spherical harmonic function, for example, a Neumann function, a Hankel function, a Bessel function, etc., such as a Hankel function of the first kind, a Hankel function of the second kind, etc., and additionally, may further include a numerical solution expression form and a matrix expression form of the spherical harmonic function, such as various numerical solution expression forms and matrix expression forms of the above various functions. In some embodiments, the solution of the equation, especially the solution of the sub-equation related to the distance information of the sound source, may be represented based on the specific function, so that the finally obtained solution of the sound wave equation may appropriately include or reflect a term related to the distance information of the sound source, which in turn is reflected in the encoding result, that is, the encoding coefficient matrix or the encoding matrix corresponding to the solution of the sound wave equation may include a component related to the distance information of the sound source. As an example, the solution of the sound wave equation, especially the solution of the sub-equation related to the distance information of the sound source, may be represented as a standing wave form or a traveling wave form based on the specific function.

The algorithm logic of encoding based on the spatial distance according to the embodiments of the present disclosure will be briefly described below.

In a traditional audio encoding scheme, especially a traditional Ambisonics scheme without considering the distance, rendering and encoding of two spatial dimensions are mainly concerned, where the former indicates the elevation angle and the latter indicates the azimuth angle, and the algorithm logic may usually be expressed as constructing an acoustic equation in the audio playback/rendering environment, and then solving it, especially solving an equation of the directional component. In particular, a sound wave equation of an acoustic signal is usually constructed in a spherical coordinate, and then the equation is transformed (for example, Laplace transform) and solved. The algorithm logic is briefly described as follows.

In particular, the sound wave equation in the spherical coordinate may be constructed by using the Laplace operator and the partial derivative of a sound pressure signal as follows:

Sound wave function in the spherical coordinate

$${∇}^{2} p - \frac{1}{{c}_{0}^{2}} \frac{{\partial }^{2} p}{\partial {t}^{2}} = 0 \qquad ( 1 )$$

Where the Laplace operator in the spherical coordinate

$${∇}^{2} ≡ \frac{1}{{r}^{2}} \frac{\partial }{\partial r} ( {r}^{2} \frac{\partial }{\partial r} ) + \frac{1}{{r}^{2} sin θ} \frac{\partial }{\partial ϑ} ( sin θ \frac{\partial }{\partial ϑ} ) + \frac{1}{{r}^{2} {sin}^{2}} \frac{{\partial }^{2}}{\partial {φ}^{2}} \qquad ( 2 )$$

Among them, the sound wave equation may be considered as an equation constructed for an acoustic/sound pressure signal p of audio, and the signal p may be expressed as p(r, θ, φ), r indicates a component/dimension related to a spatial distance, φ and θ indicates direction-related components/dimensions, which are the azimuth angle and the elevation angle, respectively, c₀ indicates the speed of sound, t indicates time, ∂ indicates the partial derivative of the sound pressure signal.

Then, variable separation may be performed for the above sound wave equation, in particular, the variable separation may be performed for three-dimensional components of the sound pressure signal, and the variable separation may also be performed for time, as follows:

$$\frac{{d}^{2} T ( t )}{{dt}^{2}} + {k}^{2} {c}_{0}^{2} T ( t ) = 0 \qquad ( 3 )$$

$$\frac{1}{{r}^{2}} \frac{d}{dr} [ {r}^{2} \frac{dR ( r )}{dr} ] + ( {k}^{2} - \frac{λ}{{r}^{2}} ) R ( r ) = 0 \qquad ( 4 )$$

$$\frac{1}{sin ϑ} \frac{d}{d ϑ} [ sin ϑ \frac{d Θ ( ϑ )}{d ϑ} ] + ( λ - \frac{{ν}^{2}}{{sin}^{2} ϑ} ) Θ ( ϑ ) = 0 \qquad ( 5 )$$

$$\frac{{d}^{2} Φ ( φ )}{d {φ}^{2}} + {ν}^{2} Φ ( φ ) = 0 \qquad ( 6 )$$

Among them, in formula (3), T indicates an equation of a relationship between sound pressure and time after the variable separation, k is a variable separation coefficient, in formula (4), R indicates an equation of the sound pressure and the distance r after the variable separation, in formula (5), ⊖ indicates an equation of the sound pressure and θ after the variable separation, λ is a variable separation coefficient, and in formula (6), Φ indicates an unknown equation of the sound pressure and φ after the variable separation, and v is a variable separation coefficient.

In a conventional scheme, the solution of the equation (4) involving the distance r has poor convergence, and the equation (4) is often ignored due to the far-field assumption of the sound field, so the conventional scheme often does not consider or ignores the solving of the equation (4). On the other hand, considering that the equations (5) and (6) already contain two dimensions in the spatial encoding φ and θ, which may represent sound field characteristics in different directions in the space, the traditional Ambisonics encoding manner is only mainly used to solve the equations (5) and (6) in the above equations, which is widely used in various engineering applications.

In view of this, the present disclosure proposes an improved spatial encoding scheme. As an example, the scheme of the present disclosure specially solves the distance term equation. In particular, a specific function (such as a Bessel function, a Neumann function, a Hankel function, etc.) may be used to construct an appropriate distance term equation, and a specific form of the equation solution may be set, for example, an acoustic signal waveform form, such as a standing wave form and a traveling wave form of the acoustic signal, etc., so that the distance term equation may be appropriately solved, thereby realizing the distance-related rendering in the audio rendering. The algorithm logic of the present disclosure will be briefly described below as an example, and the algorithm logic may perform transformation and solving of formulas in the spherical coordinate as above, and the formulas may be represented as various appropriate function equations.
Radial r part, let x=kr, equation (4) becomes

$$\frac{{d}^{2} R}{{dx}^{2}} + \frac{2}{x} \frac{dR}{dx} + [ 1 - \frac{l ( l + 1 )}{{x}^{2}} ] R = 0 \qquad ( 7 )$$

The above equation is referred to as a spherical
   Bessel Function, which is defined as

$${j}_{l} ( x ) = \sqrt{\frac{π}{2 x}} {J}_{l + 1 / 2} ( x ) ; {n}_{l} ( x ) = \sqrt{\frac{2 π}{2 x}} {N}_{l + 1 / 2} ( x ) \qquad ( 8 )$$

Where J, N are column Bessel and Neumann functions respectively. The solution of equation (7) may be expressed in a standing wave form:

$$R ( r ) = {A}_{l} {j}_{l} ( kr ) + {B}_{l} {n}_{l} ( kr ) \qquad ( 9 )$$

Hankel functions for first kind

$${h}_{l}^{( 1 )}$$

(x) and second kind

$${h}_{l}^{( 2 )}$$

(x) are defined as:

$${h}_{x}^{( 1 )} ( x ) = \sqrt{\frac{π}{2 x}} {H}_{l + 1 / 2}^{( 1 )} ( x ) = {j}_{l} ( x ) + i {n}_{l} ( x ) \qquad ( 10 )$$

$${h}_{x}^{( 2 )} ( x ) = \sqrt{\frac{π}{2 x}} {H}_{l + 1 / 2}^{( 2 )} ( x ) = {j}_{l} ( x ) - i {n}_{l} ( x )$$

Then, the solution of equation (9) can be expressed in a travelling wave form:

$$R ( r ) = {A}_{l} {h}_{l}^{( 1 )} ( kr ) + {B}_{l} {h}_{l}^{( 2 )} ( kr ) \qquad ( 11 )$$

In the above formulas, R indicates the distance function, l is a constant for separation variables of the partial differential equation, A and B are constants/coefficients for combining various functions when the combination of various functions are used to represent the distance function, where formula (10) indicates that the Hankel function may be in the form of a complex function, which includes a real part and an imaginary part.

Therefore, the distance rendering may be performed by solving of the distance term in the equation. In particular, it is equivalent to encoding the distance of the sound field by using a spherical harmonic function, such as the Hankel function and its approximate solution, so that more accurate encoding may be achieved. It should be pointed out that the solution according to the embodiments of the present disclosure does not exclude the solving of the directional component, for example, the solving of the aforementioned equations (5) and (6). As an example, the above equations (4) to (6) may be solved separately or together in the operation, which may be equivalent to obtaining the encoding parameter that considers both the distance and the direction characteristic, thereby realizing more comprehensive and realistic rendering.

An implementation of an audio signal encoding method for audio rendering according to an embodiment of the present disclosure will be described below. In particular, FIG. 3D shows a flowchart of an audio signal encoding method for audio rendering according to some embodiments of the present disclosure, and the method may include: acquiring metadata related information associated with an audio signal, the metadata related information including spatial location information related to the audio signal; and spatially encoding the audio signal based on the metadata related information associated with the audio signal, to obtain an encoded audio signal.

In some embodiments, the spatially encoding the audio signal to obtain the encoded audio signal may further include: determining an encoding parameter based on the metadata related information; and encoding the audio signal into an encoded audio signal in a specific spatial format based on the encoding parameter.

In some embodiments, the spatial location information related to the audio signal includes distance information of a sound source of the audio signal, and the determining the encoding parameter based on the metadata related information may further include constructing a distance-related encoding coefficient matrix based on the distance information of a sound source of the audio signal. Here, the distance-related encoding coefficient matrix may be included in or used as the encoding parameter.

In some embodiments, the determining the encoding parameter based on the metadata related information may further include: determining the encoding parameter based on a combination of the spatial location information of the sound source and reference spatial location information.

In some embodiments, the spatial location information of the sound source includes a distance of the sound source, the reference spatial location includes a reference distance, and the combination of the spatial location information of the sound source and the reference spatial location includes a ratio between the distance of the sound source and the reference distance, and the determining the encoding parameter based on the combination of the spatial location information of the sound source and the specific reference spatial location may further include: constructing a distance-related encoding coefficient matrix based on the ratio between the distance of the sound source and the reference distance.

In some embodiments, the metadata related information further includes directional information of the sound source of the audio signal, and the determining the encoding parameter based on the metadata related information may further include: determining an encoding matrix based on the directional information of the sound source of the audio signal, where, the encoding coefficient may be included in or used as the encoding parameter, and the encoding the audio signal into the encoded audio signal in the specific spatial format based on the encoding parameter may further include: performing encoding by multiplying or convolving the audio signal with the encoding matrix.

In some embodiments, the audio signal encoding is performed by solving an acoustic equation constructed for the audio signal, and the determining the encoding parameter based on the metadata related information may further include: determining the encoding parameter by solving, based on a specific function, a sub-equation related to the distance information of the sound source that is included in or may be derived from the acoustic equation.

In some embodiments, the audio signal encoding is performed based on solving an acoustic equation constructed for the audio signal, and the method further includes: applying a specific filter to the solving of the acoustic equation. As an example, the filter includes at least one of IIR filter and FIR filter, where the IIR filter is constructed by performing spectrum fitting by using the least square method based on frequency information in a digital domain; and the FIR filtering is obtained by performing time-frequency transform to acquire zero and pole points characteristics and then using bilinear transformation.

In some embodiments, the determining the encoding parameter based on the metadata related information may further include: determining a corresponding distance-related encoding coefficient matrix for a channel of the encoded audio signal in the specific spatial format.

FIG. 3E shows an exemplary implementation of an audio encoding method according to some embodiments of the present disclosure. In particular, the exemplary implementation may include: acquiring spatial location information of a sound source of the audio signal; constructing a distance-related encoding coefficient matrix based on the spatial location information of the sound source, and encoding the audio signal based on the distance-related encoding coefficient matrix, to obtain an encoded audio signal in a specific spatial format.

It should be pointed out that the audio encoding method according to the embodiments of the present disclosure may be implemented by various appropriate devices in various appropriate manners. In particular, it may be performed by the audio encoding device according to the embodiments of the present disclosure, for example, by corresponding units in the audio encoding device, or by other appropriate devices. It will not be described in detail here.

An audio signal decoding scheme according to an embodiment of the present disclosure will be described below. In the audio signal decoding method of the present disclosure, decoding may be implemented through operations or steps corresponding to the audio signal encoding, and may be regarded as an inverse process of encoding to some extent. In particular, for the encoded audio signal in the specific spatial format, such as the Ambisonics signal, obtained by encoding, a decoding matrix may be used for decoding thereof, for example, the Ambisonics signal may be multiplied or convolved with the decoding matrix to obtain the decoded signal. In the embodiments of the present disclosure, the decoding matrix may be obtained in an appropriate manner. As an example, the decoding matrix may also be determined based on the spatial location information related to the audio signal, for example, may be a decoding matrix related to distance and/or location in a predefined form, especially including a decoding matrix based on the spatial distance, and the decoding matrix may be determined similarly to the determination of the encoding matrix as described above, which may be the inverse of encoding. As another example, the decoding matrix may also be determined based on a rendering/playback environment, for example, based on a device configuration of the rendering/playback environment. In particular, for orthogonal encoding, the encoding and decoding matrices are transposes of each other.

In some embodiments of the present disclosure, the encoded audio signal, that is, the audio signal to be decoded, may be further processed in the decoding process, including rotation, amplitude adjustment, etc., for example, the audio signal to be decoded may be adjusted according to requirements. As an example, if the sound image needs to rotate with rotation of the listener's head, a head direction of the listener needs to be acquired by a sensor, so as to rotate the Ambisonics signal and change the amplitude thereof in advance, thereby obtaining a new Ambisonics signal, which is then decoded.

According to an embodiment of the present disclosure, an audio signal decoding device for audio rendering is provided, which is configured to: acquire an encoded audio signal, where the encoded audio signal includes an encoded audio signal obtained by the audio signal encoding device according to the embodiments of the present disclosure; and spatially decode the encoded audio signal to obtain a decoded audio signal for audio rendering. In the present disclosure, the audio signal decoder may be implemented in various appropriate manners.

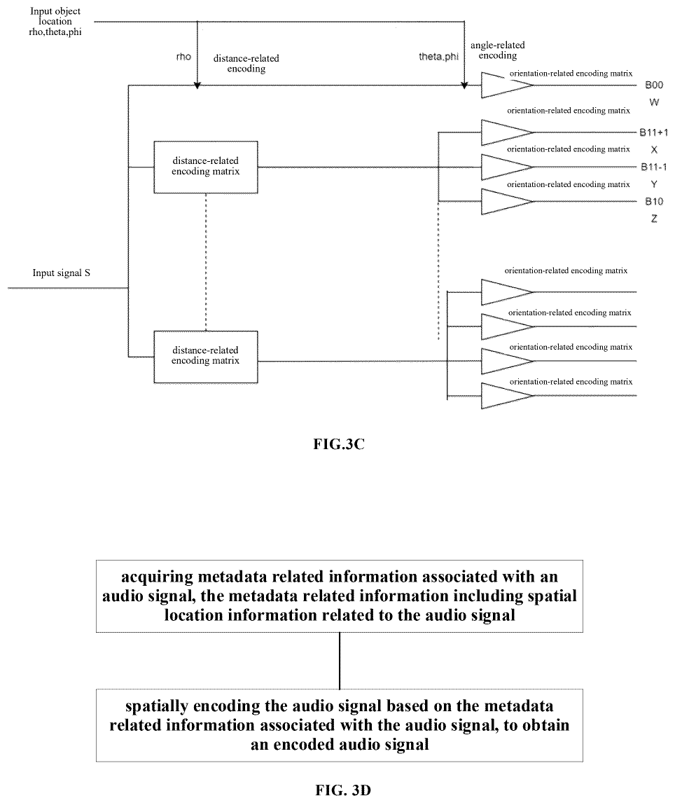

FIG. 4A shows an exemplary block diagram of an audio decoding device (audio signal decoder) according to some embodiments of the present disclosure. As shown in FIG. 4A, the audio signal decoder 400 includes an acquisition unit 410 configured to acquire an encoded audio signal, where the encoded audio signal includes an encoded audio signal obtained by the audio signal encoding device according to the embodiments of the present disclosure, and a decoding unit 420 configured to spatially decode the encoded audio signal to obtain a decoded audio signal for audio rendering.

Here, in some embodiments, the decoding matrix may be predefined based on attribute information of a sound rendering device, where the attribute information includes at least one of spatial location information or type information of the sound rendering device.

In particular, the spatial location information of the audio rendering device may include at least one of information of the audio rendering device including for example, a distance, a directional angle, etc. As an example, in a case where the audio rendering device is an external rendering device or a device far away from the listener, such as various speakers, a decoding matrix may be constructed based on the spatial location information of such speakers, thereby realizing the decoding of the encoding matrix.

According to embodiments of the present disclosure, before decoding, a pre-processing operation may also be performed: pre-processing the encoded signal based on listener location information, and then decoding the pre-processed encoded signal. In some embodiments, the listener location information includes a head direction of the listener, and the encoded signal is rotated and/or amplitude-adjusted based on the head direction of the listener. The listener here may include a real listener, or an auxiliary listening device worn on the listener, etc. Accordingly, the audio decoding device may include a pre-processing unit configured to perform the pre-processing operation, and it should be noted that such a pre-processing unit and the pre-processing operation are optional.

According to embodiments of the present disclosure, a post-processing operation may also be performed after decoding: adjusting the spatially decoded audio signal, especially adjusting an audio signal characteristic, for a specific playback device in a user application scenario, so that when the adjusted audio signal is rendered by the audio rendering device, a more appropriate acoustic experience can be presented. Accordingly, the audio decoding device may include a post-processing unit configured to perform the post-processing operation, and it should be noted that such a post-processing unit and the post-processing operation are optional.

An implementation of an audio signal decoding method for audio rendering according to an embodiment of the present disclosure will be described below. In particular, FIG. 4B shows a flowchart of an audio signal decoding method for audio rendering according to some embodiments of the present disclosure, and the method may include: acquiring an encoded audio signal, where the encoded audio signal includes an encoded audio signal obtained by the audio signal encoding device/audio signal encoding method according to the embodiments of the present disclosure; and spatially decoding the encoded audio signal to obtain a decoded audio signal for audio rendering.

In some embodiments, the spatially decoding the encoded audio signal may further include: constructing a decoding matrix, and applying the decoding matrix to the encoded audio signal to spatially decode the encoded audio signal.

In some embodiments, the audio signal decoding method may further include: pre-processing the encoded audio signal based on listener location information, and then spatially decoding the pre-processed encoded audio signal. It should be noted that the pre-processing here is optional.

In some embodiments, after decoding, the audio signal decoding method may further include a post-processing operation: for adjusting the spatially decoded audio signal, especially adjusting an audio signal characteristic, for a specific playback device in a user application scenario, so that when the adjusted audio signal is rendered by an audio rendering device, a more appropriate acoustic experience can be presented. It should be noted that the post-processing here is optional.

It should be pointed out that the audio decoding method according to embodiments of the present disclosure may be implemented by various appropriate devices in various appropriate manners. In particular, it may be performed by the audio decoding device according to embodiments of the present disclosure, for example, by corresponding units in the audio decoding device, or by other appropriate devices. It will not be described in detail here.

Some preferred embodiments of the encoding and decoding schemes according to embodiments of the present disclosure will be further described below, in which the divergence problem that may be faced when the spatial encoding is implemented by equation solving is especially considered, and the implementation of the encoding scheme is optimized.

Generally, a sound pressure signal may be expanded as

$$p ( r , ϑ , φ ) = \sum aJ ( r ) \sum bY ( ϑ , φ ) ; \qquad ( 12 )$$

where J is an encoding function of the distance of the sound source, Y is an encoding function of the angle of the sound source, and a and b are the encoded signals. For different sound field characteristics, the sound waves vary with distance. The symbol here represents all general representation manners that may represent the sound field characteristics. However, regardless of the representation, the closer the position is to the sound source, the greater the sound pressure will be, which leads to the non-convergence of the distance encoding function in some regions. In particular, the above mentions the logic of using a spherical harmonic function, such as the Hankel function, to solve the equation to perform the distance encoding according to the embodiments of the present disclosure, but it should be pointed out that in the actual use process, in some special cases, the Hankel function will diverge rapidly when the coordinate r→0, which may face a mathematical problem of infinity and cannot be solved. In view of this, based on the possibility that a ratio between two infinite numbers in mathematics may be a finite number, an embodiment of the present disclosure proposes to select a reference point in the space and optimize the equation solving by using the ratio implemented based on the reference point, which may effectively alleviate the divergence problem that may be encountered in the spatial encoding, such as the non-convergence problem, the infinity problem, etc. In particular, for a possible infinity problem in encoding signal, by selecting a reasonable reference point and recording the ratio of the signal to the reference point, the infinity problem can be transformed into a finite problem, the problem is effectively solved, and the stability of the encoding scheme is improved.

According to some embodiments of the present disclosure, reference spatial location information is further set for the audio encoding, and the audio signal encoding is further optimized based on the combination of the spatial location information of the sound source and the specific reference spatial location, which may be equivalent to adjusting or optimizing the encoding matrix to some extent, making the encoding process or the encoding matrix more stable and accurate.

According to some embodiments of the present disclosure, the combination of the spatial location information of the sound source and the specific reference spatial location includes a ratio between the spatial location information of the sound source and the reference spatial location, and/or, the spatial location information of the sound source includes a distance of the sound source, and the reference spatial location includes a reference distance. In some embodiments, the reference spatial location or the reference distance may be set in various appropriate manners. According to some embodiments of the present disclosure, the reference spatial location may be a spatial location of an audio rendering device, and the audio rendering device includes at least one of a speaker or a virtual speaker on an audio rendering side. It should be pointed out that the reference spatial location or the reference distance may also be set in other appropriate manners, and may be set to other appropriate values, which will not be described in detail here.

In this way, in embodiments of the present disclosure, by introducing the reference value, constructing relative location information based on the spatial location information related to the audio signal (in particular, for example, the distance information of the sound source of the audio signal), and solving the equation based on this, the divergence problem may be effectively solved. In particular, in the distance encoding process, the ratio of the spatial location information to the reference value is used as the relative location information to replace the spatial location information related to the audio signal in the equation, so that the infinity problem that may be faced by the equation may be transformed into a finite problem, which may solve some divergence problems, thereby enabling the equation to be solved effectively, stably and accurately, and then further improving the audio encoding and rendering. Optionally, in some examples, information about the reference point may be retained after encoding, so as to realize reverse processing based on this information during decoding, for example, construct an inverse matrix of the encoding matrix, thereby avoiding the divergence problem in the encoding process.

The following is an example of a spherical harmonic function used in Ambisonics. According to the solution of formula (1), on the basis of the spherical harmonic function, multiplying by the solution of the distance term, a solution of an overall sound wave equation (which may also be referred to as a vibration equation) may be obtained:

$$p ( r , ϑ , φ ) = {\sum }_{l = 0}^{∞} {j}^{l} {j}_{l} ( kr ) {\sum }_{0 \leq m \leq l , σ = \pm 1} {B}_{l m}^{σ} {Y}_{l m}^{σ} ( ϑ , φ ) \qquad ( 13 )$$

where jₗ(kr) is a family of spherical harmonic Bessel function (or Neumann function, or Hankel function, which will not be specifically distinguished in the following), k=2πf/c. According to the relevant mathematical relationship, an Ambisonics encoding equation with distance may be obtained. For a point source located at (ρ,θ,φ), here ρ indicates the spatial distance, and the encoded signal thereof is:

$${B}_{lm}^{σ} = S \cdot {Γ}_{l} ( k ρ ) \cdot {Y}_{lm}^{σ} ( ϑ , φ ) \qquad ( 14 )$$

Among them,

$${Γ}_{l} ( k ρ ) = {kd}_{ref} {h}_{l}^{-} ( k ρ ) {j}^{- ( l + 1 )} \qquad ( 15 )$$

$${h}_{l}^{-} ( kr ) = {j}_{l} ( kr ) - {jn}_{l} ( kr ) \qquad ( 16 )$$

$${h}_{m}^{-} ( k r )$$

is a spherical Hankel equation of the second kind, and here, the spherical Hankel equation can be simply expressed as:

$${h}_{0}^{( 1 )} ( x ) = - \frac{i}{x} {e}^{ix} ; {h}_{1}^{( 1 )} ( x ) = ( - \frac{1}{x} - \frac{i}{{x}^{2}} ) {e}^{ix} \\ {h}_{2}^{( 1 )} ( x ) = ( \frac{i}{x} - \frac{3}{{x}^{2}} - \frac{3 i}{{x}^{3}} ) {e}^{ix} \\ {h}_{0}^{( 2 )} ( x ) = \frac{i}{x} {e}^{- ix} ; {h}_{1}^{( 2 )} ( x ) = ( - \frac{1}{x} + \frac{i}{{x}^{2}} ) {e}^{- ix} \\ {h}_{2}^{( 2 )} ( x ) = ( - \frac{i}{x} - \frac{3}{{x}^{2}} + \frac{3 i}{{x}^{3}} ) {e}^{- iz} \qquad ( 17 )$$

Among them,

$${B}_{lm}^{σ}$$

may indicate encoded audio signals, such as audio signals in various appropriate formats, such as Ambisonics audio signals, in which the distance parameter is considered, and additionally the directional parameter is also considered.

It may be seen that the spherical Hankel equation includes two parts, one of which is a derivative term of the distance, and the other is the phase delay term.
For the distance term, it may be seen that it contains multiple powers of a reciprocal of the distance. Compared with the traditional Ambisonics in which only the energy attenuation of the inverse proportional primary term is considered, the Ambisonics scheme with distance considers the higher-order distance attenuation term, which would be more accurate.
For the phase delay item, that is, the phase delay item causing kρ, it is embodied as the overall time delay.

In summary, Γₗ contains the phase delay term and the amplitude attenuation term. Compared with a traditional approximate logic using an inverse proportional relationship, the amplitude is more accurate, especially the low-frequency increment amplitude is obtained by accurate calculation, which is more accurate. In addition, the phase information may also be contained, which can reasonably adjust the phase, and reasonably present the time-delay problem of sound wave propagation, so that encoding of the sound field is more accurate, bringing a more realistic effect. It should be pointed out that in the context, Γₗ may essentially correspond to the encoding coefficient matrix, especially the distance-related encoding coefficient matrix,

$${Γ}_{l} ( k ρ ) \cdot {Y}_{lm}^{σ} ( ϑ , φ )$$

may essentially correspond to the encoding coefficient matrix obtained by further considering the directivity, which may indicate that the encoding coefficient matrix is constructed by further considering the directional characteristics on the basis of the obtained distance-related encoding coefficient matrix.

It may be seen from formula (17) that the Hankel function diverges rapidly at the origin. At this time, the scheme of the present disclosure may assume that there is a reference sound source position (ref), assuming that the distance of the sound source is p, and the distance of the reference point is R, and the distance transfer function matrix is

$${H}_{l}^{( ρ / c , R / c )} ( ω ) = \frac{{F}_{l}^{( ρ / c )} ( ω )}{{F}_{l}^{( R / c )} ( ω )} \qquad ( 18 )$$

Among them, F means distance equations corresponding to spherical harmonic functions and sound wave vibration equations with different orders, which is a spherical Bessel function or a combination form of its family functions under the Ambisonics encoding logic, and of course, other types of distance-related encoding functions/distance equations are also included here. It may be seen that when ρ<R, the absolute value of the correction function is greater than 1; it may be seen that when ρ>R, the abs of the correction function is less than 1. For the spherical Bessel function, it may be seen that the ratio does not diverge.

Therefore, the finally encoded form under the Ambisonics encoding may be converted to

$${\tilde{B}}_{lm}^{σ ( R / c )} = S \cdot {H}_{l}^{( ρ / c , R / c )} ( ω ) \cdot {Y}_{lm}^{σ} ( θ , δ ) \qquad ( 19 )$$

Among them, S is a signal to be encoded, H is a distance-direction spherical harmonic function encoding basis set with the reference point, which may correspond to the encoding coefficient matrix, especially the distance-related encoding coefficient matrix, that is, the encoding coefficient matrix considering the reference point; Y is a basis set of the spherical harmonic equation, and similarly,

$${H}_{l}^{( ρ / c , R / c )} ( ω ) \cdot {Y}_{lm}^{σ} ( θ , δ )$$

may correspond to the encoding matrix, which may indicate that the encoding matrix is constructed by further considering the directional characteristics on the basis of obtaining the distance-related encoding coefficient matrix considering the reference point. It should be noted that this embodiment shows the distance encoding logic under the Ambisonics encoding mode; for other distance encodings that express the sound field in other forms, strategies that may improve the divergence problem by selecting the reference point should be included.

The concept of setting the reference point is especially beneficial for audio encoding/decoding and rendering in a scenario close to the sound source. It should be pointed out that the concept of the reference point is not necessary. In some implementations, the configuration of the reference point may depend on the setting on the decoding side. For example, if a decoding method using other optimization methods is used on the decoding side, and if a far-field assumption is made during decoding, it may be assumed that the decoding speaker is at a far position and then the formula may be substituted to calculate the coefficient. In this case, an appropriate decoding scheme may be used for decoding, and/or some optimization strategies may be used to directly optimize the decoded signal without assuming the speaker position. In this way, in the encoding processing on the encoding side, there is no need to set a reference point for encoding.

Some other embodiments according to the present disclosure will be further described below, in which an optimized encoding scheme is proposed to enable fast calculation. In some cases, the final solving result of the Hankel function may be complicated, and therefore it is desired to propose an improved solving method to accelerate or facilitate the solving of the equation function, for example, to enable the scheme to perform fast calculation or even real-time calculation. In particular, according to a logic of an embodiment, since a distance r often appears with the wave number k, and for the sound wave with the sound speed c, its corresponding frequency is

$$f = \frac{ck}{2 π} ,$$

so in essence, the final distance correction equation is related to the frequency. In view of this, the present disclosure proposes an optimized filter design to optimize the solving scheme. The filter here may involve at least one of infinite impulse response (IIR) filter and finite impulse response (FIR) filter. In addition, for sound sources with different orders and different distances, there are different filter amplitudes and phase responses. Therefore, it is desired to further optimize the filter design to optimize the solving scheme.

In view of this, the present disclosure proposes an optimized FIR filter design strategy and IIR filter design strategy, which will be described below for the encoding mode under the Ambisonics logic, but similar strategies may be adopted for encoding modes under other sound field representation types.

According to some embodiments of the present disclosure, it is proposed to optimize the filter design for encoding, where the filter includes at least one of an IIR filter or an FIR filter. In particular, in some embodiments, the encoding matrix may be determined based on at least one of an optimized IIR filter or an optimized FIR filter.

As an example, substituting a spherical Bessel polynomial into formula (19), formula (19) is rewritten as follows:

$${\tilde{B}}_{lm}^{σ ( R / c )} = S \cdot {H}_{l}^{( ρ / c , R / c )} ( ω ) \cdot {Y}_{lm}^{σ} ( θ , δ ) \qquad ( 20 )$$

That is, the core is to solve a function

$${H}_{l}^{( ρ / c , R / c )} ( ω ) \qquad ( 21 )$$

With respect to its general solution form, it can be expressed as

$${H}_{l}^{( ρ / c , R / c )} ( ω ) = \sum {a}_{m} {ω}^{m} \qquad ( 22 )$$

Meanwhile, in the encoding process, such as the solving process of the above encoding formula, a filter can be introduced for solving, and in particular, a filter design is introduced to optimize the design and simplification of the coefficient matrix. An IIR filter or an FIR filter may be used for the design. The FIR filter may be designed by using, including but not limited to, the least square method in the digital domain. The IIR filter may be implemented by means of polynomial approximation.
FIR filter: According to formula (20), the frequency information may be substituted, and then the least square method is used to fit the frequency spectrum, so that the filter is implemented with a lower-order FIR filter, and then the frequency domain algorithm and the overlapping convolution scheme are used for implementation.
IIR filter: According to formula (20), the Laplace transform is used for time-frequency domain conversion to acquire the zero and pole point characteristics, and then the bilinear transformation method is used to obtain the iteration equation, and then the iteration equation is disassembled into a parallel or series form, so that it may be realized by using a second-order IIR filter bank. In the calculation process, a SIMD instruction set may be used for optimization and speed up.

Therefore, according to embodiments of the present disclosure, a filter, including IIR filter or FIR filter, is used to simplify the solution of the Hankel function, so that the signal may be optimized by using a filter optimization strategy, and calculation may be performed by using a lower-order iteration strategy and an existing fast algorithm for digital signal processing.

Some other embodiments according to the present disclosure will be further described below, in which the optimization of decoding processing, especially the independence of encoding and decoding, is mainly considered.

Generally, the process corresponding to encoding is decoding, but decoding is often performed on a client, and whether a new encoding method may be compatible with an original decoding scheme used by the client will have an obvious impact on the overall effect of the scheme. If it is compatible, it will help promote the scheme and have a minimal impact on the client. Therefore, an improved encoding/decoding optimization needs to be proposed to improve scheme compatibility.

As mentioned above, for near-field decoding, the decoding matrix converges and is stable, but for near-field encoding, the encoding matrix cannot be actually used due to the divergence of the Hankel function, the fact that the Hankel functions, when the orders are consistent, becomes infinite under the same order may be used to fuse encoding and decoding, thereby avoiding the divergence problem. In particular, the parameter configuration of the decoding end may be directly used in the design of the encoding scheme, and in particular, the position parameter of the decoding end may be used as the reference value setting of the encoding end, so that the combination of encoding and decoding may be realized.

In view of this, in some embodiments, the speaker location information during playback may be applied to the encoding end to combine encoding and decoding. In particular, for a state where the distance of the source is p and the speaker location during playback is R, the both information may be directly substituted into the above formula (19) for calculation. At this time, since the distance p of the sound source and the distance R of the speaker have been already included in the encoding process, in the decoding process, only the traditional Ambisonics decoding matrix is needed for decoding, which may reuse the traditional Ambisonics decoding scheme for implementation.

As an example, for the decoding case, if there is an actual playback speaker, the distance of the speaker used for decoding may be directly substituted during encoding; if a virtual speaker is used for decoding and then post-processing is performed, the distance of the virtual speaker used for decoding may be directly substituted during encoding. For other decoding methods using other optimization methods, if a far-field assumption is made during decoding, it may be assumed that the speaker at the decoding end is at a far position, and then the formula may be substituted to calculate the coefficients.

Therefore, in the encoding process, for a possible speaker location (including a virtual speaker) for decoding, the reference location can be directly selected as the speaker location for decoding. At this time, distance encoding and decoding may be combined into the encoding process, so that a traditional decoding strategy may be reused in the decoding process, and thus the client does not need to be changed.

Some exemplary implementations of the audio signal encoding processing/audio signal encoder according to the embodiments of the present disclosure will be described below, which may be implemented in conjunction with the embodiments of the audio signal encoding and decoding described above.

According to embodiments of the present disclosure, a specific spatial format of the encoded audio signal may be a spatial format that may be supported by the audio rendering system, and for example, the encoded audio signal may be played back to the user in different user application scenarios, for example, different audio playback environments. In a sense, the encoded audio signal in the specific spatial format may be used as an intermediate signal medium, that is, it indicates that an intermediate signal in a common format is encoded from the input audio signal that may contain various spatial representations, and decoding processing is performed from the intermediate signal for rendering. The encoded audio signal in the specific spatial format may be the audio signal in the specific spatial format as described above, such as FOA, HOA, MOA, etc., which will not be described in detail here. Therefore, for an audio signal that may have at least one of a plurality of different spatial representation manners, spatial encoding may be performed on the audio signal to obtain an encoded audio signal in a specific spatial format that may be used for playback in a user application scenario, that is, even if the audio signal may contain different content formats/audio representations, an audio signal in a public or common spatial format may still be obtained by encoding. In some embodiments, the encoded audio signal may be added to the intermediate signal, for example, encoded as the intermediate signal. In another embodiment, the encoded audio signal may also be directly transmitted/passed through to the spatial decoder without being added to the intermediate signal. In this way, the audio signal encoding module may be compatible with various types of input signals to obtain an encoded audio signal in a common spatial format, thereby enabling the audio rendering processing to be efficiently performed.

In some embodiments, the spatial encoding for the object-based audio signal may be performed for each of one or more sound objects included in the audio signal, and the encoding process for each sound object may be performed as described above. In some embodiments, the audio signal encoder is further configured to perform weighted combination on the encoded signals of object-based audio representation signals based on weights for sound objects defined in metadata. The weight may be set in various appropriate manners, for example, preset, set empirically, set based on the strength, priority, etc., of the signal object, etc., which will not be described in detail here. In particular, in the case where the audio signal contains a plurality of sound objects, for each sound object in the audio signal, after spatially encoding the object-based audio representation signal based on information related to spatial propagation of the sound object of the audio signal, for example, after spatially encoding the audio representation signal for a spatial propagation path of each sound object as described above, the encoded audio signals of the sound objects may be weighted and combined using a weight for each sound object included in the metadata associated with the audio representation signal.

In some embodiments, the spatial encoding for the object-based audio signal (such as the spatial encoding for the object-based audio signal as described above) may be performed for one or more spatial propagation paths from a sound object to a listener, respectively. In particular, in the case where there is one spatial propagation path from the sound object to the listener, the spatial encoding for the object-based audio signal is performed for the spatial propagation path, and in the case where there are a plurality of spatial propagation paths from the sound object to the listener, the spatial encoding may be performed for at least one of, or even all of, the plurality of spatial propagation paths. Specifically, information related to each spatial propagation path from the sound object to the listener may be considered separately, and then a corresponding encoding process is performed for the audio signal corresponding to the spatial propagation path, and then the encoding results of the spatial propagation paths may be combined to obtain the encoding result for the sound object. The spatial propagation path between the sound object and the listener may be determined in various appropriate manners, in particular by acquiring, including but not limited to, spatial location information. In some embodiments, the location information of the spatial propagation path may include a direction angle at which the spatial propagation path reaches the listener or a direction angle of the spatial propagation path relative to a coordinate system. In some embodiments, the spherical harmonic function based on the position angle of the spatial propagation path may be any appropriate form of spherical harmonic function.

In some embodiments, the spatial audio encoding for the object-based audio signal may further be based on a length of the spatial propagation path from the sound object in the audio signal to the listener, and at least one of a near-field compensation function or a spreading function may be used to encode the audio signal. For example, based on the length of the spatial propagation path, at least one of the near-field compensation function or the spreading function may be applied to the audio signal of the sound object for the propagation path, so as to perform appropriate audio signal compensation and enhance the effect.

The audio encoding according to the present disclosure may be performed for various audio signals, respectively, and in particular, each type of audio signal may be encoded. In the case where a plurality of audio signals are included, the encoded audio signals may also be combined, and in particular, weighting processing may be performed. According to some embodiments, the audio signal encoding module may be configured to weight the audio signals based on the metadata information. In particular, the audio signal encoding module may be configured to perform weighting according to weights in the metadata. The metadata may be associated with the audio signal to be encoded that is acquired by the audio signal encoding module, for example, associated with signals/audio representation signals having various audio content formats, as described above. In particular, in some embodiments, the audio signal encoding module may also be configured to weight the acquired audio signal, especially the audio signal having a specific audio content format, based on the metadata associated with the audio signal. In some other embodiments, the audio signal encoding module may also be configured to perform additional processing, such as weighting and rotation, on the encoded audio signal. In particular, the audio signal encoding module may be configured to convert the audio signal in the specific audio content format to obtain the audio signal in the specific spatial format, and then weight the obtained audio signal in the specific spatial format based on the metadata, so as to obtain the intermediate signal. In some embodiments, the audio signal encoding module may be configured to perform further processing, such as format conversion and rotation, on the audio signal in the specific spatial format that is obtained through the conversion based on the metadata. In some embodiments, the audio signal encoding module may be configured to convert the encoded or directly input audio signal in the specific spatial format to meet a format supported and constrained by the current system, for example, perform the conversion in terms of a channel arrangement method, a regularization method, etc. to meet requirements of the system.

In some embodiments, the audio signal encoder is configured to spatially encode the object-based audio signal according to at least one of a filtering function or a spherical harmonic function, where the filtering function may be a filtering function for filtering the audio signal based on path energy intensity of the spatial propagation path from a sound object in the audio signal to the listener, and the spherical harmonic function may be a spherical harmonic function based on the location information of the spatial propagation path. In some embodiments, the audio signal encoding may be performed based on a combination of both the filtering function and the spherical harmonic function. As an example, the audio signal encoding may be performed based on a product of both the filtering function and the spherical harmonic function.

In some embodiments, the spatial audio encoding for the object-based audio signal may further be based on a delay of the sound object in spatial propagation, for example, based on a propagation duration of the spatial propagation path. In this case, the filtering function for filtering the audio signal based on the path energy intensity is a filtering function for filtering the audio signal of the sound object before propagating along the spatial propagation path based on the path intensity energy of the path. In some embodiments, the audio signal of the sound object before propagating along the spatial propagation path refers to an audio signal at a time moment before a time required for the sound object to reach the listener along the spatial propagation path, for example, an audio signal of the sound object before the propagation duration.

In some embodiments, the location information of the spatial propagation path may include a direction angle at which the spatial propagation path reaches the listener or a direction angle of the spatial propagation path relative to a coordinate system.

Some exemplary implementations of the audio signal decoding processing/audio signal decoder according to the embodiments of the present disclosure will be described below, which may be implemented in combination with the embodiments of the audio signal encoding and decoding described above.

In some embodiments, in the case where the audio rendering device is a device adjacent to the listener, such as a wearing device of the listener, such as a headphone, an earplug, etc., the type information of the device may be directly considered to set the decoding matrix, for example, the device ID indicates the device type, has a corresponding decoding matrix, etc., so that an appropriate decoding matrix may be selected to implement decoding.

According to embodiments of the present disclosure, after the audio signal is subjected to audio encoding or directly transmitted/passed through as described above, audio decoding processing will be performed on the encoded audio signal or the directly transmitted/passed audio signal, so as to obtain an audio signal suitable for playback/rendering in the user application scenario. In particular, such an encoded audio signal or directly transmitted/passed audio signal may be referred to as a to-be-decoded signal, which may correspond to the audio signal in the specific spatial format or the intermediate signal as described above. As an example, the audio signal in the specific spatial format may be the intermediate signal, or may be an audio signal directly transmitted/passed through to the spatial decoder, including an unencoded audio signal, or an encoded audio signal that has been spatially encoded but is not included in the intermediate signal, such as a non-narrative channel signal, a reverberated binaural signal, etc. The audio decoding processing may be performed by the audio signal decoding module.

According to embodiments of the present disclosure, the audio signal decoding module may decode the intermediate signal and the pass-through signal to a playback device according to a playback mode. Therefore, the to-be-decoded audio signal may be converted into a format suitable for playback through a playback device in a user application scenario, such as an audio playback environment, or an audio rendering environment. According to embodiments of the present disclosure, the playback mode may be related to the configuration of the playback device in the user application scenario. In particular, depending on the configuration information of the playback device in the user application scenario, such as the identifier, type, arrangement, etc., of the playback device, a corresponding decoding manner may be adopted. In this way, the decoded audio signal may be suitable for a specific type of playback environment, especially for the playback device in the playback environment, thereby achieving compatibility with various types of playback environments. As an example, the audio signal decoder may perform decoding based on information related to the type of the user application scenario, the information may be a type indicator of the user application scenario, for example, a type indicator of the rendering device/playback device in the user application scenario, such as a renderer ID, so that the decoding processing corresponding to the renderer ID may be performed to obtain the audio signal suitable for playback through the renderer. As an example, the renderer ID may be as described above, and each renderer ID may correspond to a specific renderer arrangement/playback scenario/playback device arrangement, etc., so that an audio signal suitable for playback through the renderer arrangement/playback scenario/playback device arrangement, etc., corresponding to the renderer ID may be obtained by decoding. In some embodiments, the playback mode, such as the renderer ID, may be pre-specified, transmitted to the rendering end, or input through an input port. In some embodiments, the audio signal decoder decodes the audio signal in the specific spatial format by using a decoding manner corresponding to the playback device in the user application scenario.

In some embodiments, the playback device in the user application scenario may include a speaker array, which may correspond to a speaker playback/rendering scenario. In this case, the audio signal decoder may use a decoding matrix corresponding to the speaker array in the user application scenario to decode the audio signal in the specific spatial format. As an example, such a user application scenario may correspond to a specific renderer ID, such as the renderer ID2. In particular, for example, corresponding identifiers may also be respectively set according to the type of the speaker array, so as to more accurately indicate the user application scenario. For example, corresponding identifiers may be respectively set for a standard speaker array, a customized speaker array, etc.

The decoding matrix may be determined depending on the configuration information of the speaker array, such as the type, arrangement, etc., of the speaker array. In some embodiments, in the case where the playback device in the user application scenario is a predetermined speaker array, the decoding matrix is a decoding matrix that is built in the audio signal decoder or received from the outside and that corresponds to the predetermined speaker array. In particular, the decoding matrix may be a preset decoding matrix, which may be pre-stored in the decoding module, for example, stored in a database in association/correspondence with the type of the speaker array, or provided to the decoding module in other manners. Thus, the decoding module may call the corresponding decoding matrix according to the known predetermined speaker array type to perform the decoding processing. The decoding matrix may be in various appropriate forms, for example, may contain a gain, such as a gain value from an HOA track/channel to a speaker, so that the gain may be directly applied to the HOA signal to generate an output audio channel, so as to render the HOA signal into the speaker array.

As an example, for a standard speaker array defined in a standard, such as 5.1 speaker, the decoder may have built-in decoding matrix coefficients, and the playback signal L may be obtained by multiplying the intermediate signal by the decoding matrix.

$$L = {DS}_{N} ,$$

where L is the speaker array signal, D is the decoding matrix, and S_{N} is the intermediate signal, which is obtained as described above. On the other hand, for the audio signal that is directly transmitted/passed through, the signal may be converted into the speaker array according to the definition of the standard speaker, for example, the signal may be multiplied by the decoding matrix as described above, or other suitable methods may be used, such as vector-base amplitude panning (VBAP), etc. As another example, in the case of spatial decoding for a specific speaker array, for a sound bar or some more specific speaker arrays, the speaker manufacturer may be required to provide a correspondingly designed decoding matrix. The system provides a decoding matrix setting interface to receive the related parameters of the decoding matrix corresponding to the specific speaker array, so that the received decoding matrix may be used to perform the decoding processing, as described above.

In some other embodiments, in the case where the playback device in the user application scenario is a customized speaker array, the decoding matrix is a decoding matrix calculated according to an arrangement of the customized speaker array. As an example, the decoding matrix is calculated according to an azimuth and a pitch angle of each speaker in the speaker array or three-dimensional coordinate values of the speaker. As an example, in the spatial decoding of the customized speaker array, in the scenario of the customized speaker array, such speakers usually have a spherical, semi-spherical design or a rectangular shape, which may surround or semi-surround the listener. The decoding module may calculate the decoding matrix according to the arrangement of the customized speaker, which requires the input of the azimuth and pitch angle of each speaker, or the three-dimensional coordinate values of the speaker. The calculation method of the speaker decoding matrix may include SAD (Sampling Ambisonic Decoder), MMD (Mode Matching Decoder), EPAD (Energy preserved Ambisonic Decoder), AllRAD (All Round Ambisonic Decoder), etc.

According to some embodiments of the present disclosure, in the case where the playback device in the user application scenario is a headphone, which may correspond to a headphone rendering/playback, binaural rendering/playback and other scenarios, the audio signal decoder is configured to directly decode the audio signal to be decoded into a binaural signal as the decoded audio signal, or obtain a decoded signal as the decoded audio signal through speaker virtualization. As an example, such a user application scenario may correspond to a specific renderer ID, such as the renderer ID1. As an example, for the playback environment of the headphone, there may be various appropriate decoding manners. In some embodiments, for example, the to-be-decoded signal, such as the intermediate signal described above, may be directly decoded into a binaural signal. In particular, the decoding processing may be directly performed on the to-be-decoded signal, for example, a rotation matrix may be determined according to the listener's posture to convert the HOA signal, and then the HOA channels/tracks may be adjusted, for example, convolution may be performed, such as, using a gain matrix, a harmonic function, HRIR (Head Related Impulse Response), spherical harmonic HRIR, etc., for example, frequency domain convolution, so that the binaural signal may be obtained. In other words, such a process may also be seen as the HOA signal being directly multiplied by the decoding matrix, and the decoding matrix may contain a rotation matrix, a gain matrix, a harmonic function, etc. As an example, typical methods include LS (least squares), Magnitude LS, SPR (Spatial resampling), etc. The pass-through signal, which is usually a binaural signal, is directly played back. As another example, indirect rendering may also be performed, that is, a speaker array is used first, and then HRTF convolution is performed according to the location of the speaker to perform virtualization processing on the speaker, thereby obtaining the decoded signal.

In some embodiments, in the audio decoding processing, the to-be-decoded audio signal may also be processed based on the metadata information associated with the to-be-decoded audio signal. In particular, spatial transformation may be performed on the to-be-decoded audio signal according to the spatial transformation information in the metadata information, for example, when it is indicated in the metadata information that rotation is required, the sound field rotation operation may be performed on the audio representation signal to be decoded based on the rotation information indicated in the metadata. As an example, first, according to the processing method of the previous module and the rotation information in the metadata, the intermediate signal is multiplied by the rotation matrix as needed to obtain the rotated intermediate signal, and then the rotated intermediate signal may be decoded. It should be pointed out that the spatial transformation here, such as spatial rotation, may be performed alternatively to the spatial encoding in the spatial encoding processing as described above, for example, spatial rotation.

An exemplary implementation of the audio processing scheme, especially the audio rendering scheme, according to some embodiments of the present disclosure will be described below, which relates to a process of obtaining, based on an input audio signal, an output audio signal suitable for rendering in a user application scenario, especially being presented/played back to the user through a device in the playback environment. The audio rendering scheme according to the embodiments of the present disclosure may include the audio encoding/decoding scheme according to the embodiments of the present disclosure as described previously, and may also include other appropriate audio processing, which will be further described in detail below.

In the process, an audio signal in a specific spatial format that may be used for playback in the user application scenario may be obtained based on the input audio signal. In the audio rendering processing according to the present disclosure, the audio signal in the specific spatial format is obtained based on the input audio signal. Depending on the signal format of the input signal, such as the signal representation manner, the encoding mode, the audio content format, etc., for some signal formats, the input signal or some signals included in the input signal may be directly transmitted/passed through to the decoding block to be decoded without spatial audio processing. In this case, these signals may be directly used as the audio signals in the specific spatial format, without being subject to spatial audio processing. In particular, the audio signal in the specific spatial format includes an audio signal that does not need to be spatially encoded in the audio signals having the audio content format compatible with the audio rendering system that are obtained from the input audio signal. In some embodiments, the audio signals having the audio content format compatible with the audio rendering system may contain at least one of an object-based audio representation signal, a scene-based audio representation signal, or a channel-based audio representation signal. In some embodiments, the audio signal that does not need to be spatially encoded includes at least one of a non-narrative channel audio track in the channel-based audio signal, or a narrative channel audio track that does not need to be subjected to spatial audio processing. As an example, when the format of the input audio signal directly corresponds to the specific spatial format, the input audio signal may be directly used as the audio signal in the specific spatial format, that is, directly transmitted/passed through to the audio signal spatial decoder.

In some embodiments, for other signal formats, the input signal or some signals included in the input signal may be subjected to spatial audio processing to obtain the audio signal in the specific spatial format. As an example, the spatial audio processing may include, but not limited to, pre-processing, audio information processing, audio signal spatial encoding, etc., which may be implemented by appropriate devices, elements, etc., and these devices and elements may be implemented in various appropriate manners, such as hardware, firmware, software, etc.

Then, the audio signal in the specific spatial format may be decoded, and the decoded audio signal may thus be presented to the user through the audio rendering device/audio playback device in the user application scenario, for example, in the audio playback environment, so as to meet the user's requirements.

Such a process may be implemented by the audio rendering system according to the embodiments of the present disclosure, especially through various appropriate modules in the audio rendering system. Some exemplary implementations in the above process will be described below.

### (Input) Audio Signal Acquisition

The signal suitable for rendering processing by the audio rendering system may be acquired in various appropriate manners. According to embodiments of the present disclosure, the signal suitable for rendering processing by the audio rendering system may have an audio content format compatible with the audio rendering system, for example, may be referred to an audio signal in the specific audio content format. The audio content format may correspond to an audio representation manner, and the specific audio content format may contain a specific audio representation manner, which may contain at least one of an object-based audio representation signal, a scene-based audio representation signal, or a channel-based audio representation signal. In some embodiments, the audio signal in the specific audio content format may be directly input to the audio rendering system, that is, the audio signal in the specific audio content format may be directly input as an input signal, so that it may be directly acquired. In some other embodiments, the audio signal in the specific audio content format may be acquired from the audio signal input to the audio rendering system. As an example, the input audio signal may be an audio signal in another format, for example, a specific combination signal containing the audio signal in the specific audio content format, and a signal in another format. In this case, the audio signal in the specific audio content format may be acquired by parsing the input audio signal. In this case, the input signal acquisition module may be referred to as or contain an audio signal parsing module, and the signal processing performed by the input signal parsing module may be referred to as signal pre-processing, especially the processing before audio signal encoding. As an example, the audio signal parsing module may be or may be included in a pre-processing module, and the operations performed by the audio signal parsing module may also be implemented by the pre-processing module.

### Audio Signal Parsing

According to some embodiments of the present disclosure, in view of different application scenarios, the audio signal may be input in different input formats. Therefore, audio signal parsing may be performed before the audio rendering processing so as to be compatible with inputs in different formats. Such audio signal parsing processing may be considered as a kind of pre-processing, for example, which may be performed by the audio signal parsing module. In some embodiments, the audio signal parsing module or the pre-processing module may be configured to obtain, from the input audio signal, the audio signal having the audio content format compatible with the audio rendering system, and in particular, the input signal in any spatial audio exchange format may be parsed, so as to obtain the audio signal having the audio content format compatible with the audio rendering system.

According to some other embodiments of the present disclosure, the audio signal parsing module or the pre-processing module is configured to parse the input signal in any spatial audio exchange format, and convert the signal into a format specified by the audio rendering system according to the type of signal format. In particular, in some embodiments, the acquired audio signal having the audio content format compatible with the audio rendering system may be further converted to enable the audio signal to have a predetermined format, especially the predetermined format of the audio rendering system, for example, the signal may be converted into the format specified by the audio rendering system according to the type of signal format. In particular, the predetermined format may correspond to a predetermined configuration parameter of the audio signal in the specific audio content format, so that in the audio signal parsing operation, the audio signal in the specific audio content format may be further converted into the predetermined configuration parameter. In some embodiments, in the case where the audio signal having the audio content format compatible with the audio rendering system is a scene-based audio representation signal, the audio signal parsing module or the pre-processing module is configured to convert the scene-based audio signals with different channel ordering and normalization coefficients into channel ordering and normalization coefficients specified by the audio rendering system.

As an example, the pre-processing module may be configured to pre-process the distributed signal in any spatial audio exchange format. As an example, the audio signal having a specific audio representation manner may be acquired from the input audio signal. In particular, for example, for a signal in any spatial audio exchange format for distribution, regardless of whether it is a non-streaming or streaming transmission signal, this kind of signal may be divided, by the input signal parser according to the signal representation method of spatial audio, into three types of signals, that is, at least one of a scene-based audio representation signal, a channel-based audio representation signal, or an object-based audio representation signal, and the metadata corresponding to this kind of signal. On the other hand, optionally, the spatial audio signal may be further converted into a predetermined format, for example, a format predetermined or specified by the audio rendering system or even the audio system. Certainly, this format conversion is not necessary. As an example, in the pre-processing, the signal may also be converted into a system-constrained format according to the format type. For example, for the scene-based spatial audio representation signal HOA, different channel ordering (such as ACN, Ambisonic Channel Number, FuMa, Furse-Malham, and SID, Single index designation) and different normalization coefficients (N3D, SN3D, FuMa) are used in different data exchange formats. In this step, they may be converted into a certain agreed channel ordering and normalization coefficient, such as (ACN+SN3D).

In some embodiments, the input audio signal is directly used as the audio signal in the specific spatial format, that is, the input audio signal does not need to be pre-processed, but is directly passed/transmitted to the audio signal decoder for processing. In some embodiments, the pre-processing module includes an application interface, which is configured to directly receive the input audio signal and directly transmit the input audio signal to the audio signal decoder.

As an example, the pre-processing module may implement pre-processing of a custom application input signal. In some custom applications, since it is directly performed on the consumer side, the conversion operation for the spatial audio exchange format may be omitted, and an API can be provided in the rendering system for the application to directly transmit the corresponding audio data and metadata to the system.

According to embodiments of the present disclosure, the audio signal in the specific spatial format may be obtained by spatially encoding the input audio signal, in particular by spatially encoding the audio signal obtained through pre-processing and parsing. Here, the spatial encoding may be implemented by the encoding solution according to the embodiments of the present disclosure.

### Acquisition of Metadata Information

In embodiments of the present disclosure, the metadata information related to the audio signal may also be acquired. In the embodiments of the present disclosure, the metadata information may contain various appropriate data. As an example, the metadata information may contain information corresponding to the audio content format of the audio signal, for example, corresponding information depending on the audio representation manner of the parsed audio signal, such as at least one of a scene-based audio representation signal, a channel-based audio representation signal, or an object-based audio representation signal.

In embodiments of the present disclosure, the metadata information may include metadata directly input together with the input signal, and/or may further include related information further derived from the metadata, and the related information may include an audio parameter related to the audio signal, which may be used for further processing, such as spatial encoding, of the audio signal.

In some embodiments, the metadata information associated with the audio signal may be acquired in various appropriate manners. In some embodiments, the metadata information may be directly input when the audio signal is input, or may be acquired and provided by another device in the system or a third-party device. In an example, the metadata information may be separated from the input audio signal, and may be separately input to the audio rendering system or input together with the input audio signal. In some other embodiments, the information processing module may perform extraction on signals in different formats and calculate corresponding parameters. In particular, the information processing module may process the metadata associated with the audio signal to obtain appropriate information as the metadata information for subsequent signal processing, including signal spatial encoding and decoding processing. In an implementation, for the received input audio signal, the audio signal parsing module may obtain, from the input audio signal, an audio signal having an audio content format compatible with the audio rendering system and the metadata information related to the audio signal.

In some embodiments, the metadata information may be obtained through audio information processing, which may be performed by the audio information processing module.

### Audio Information Processing

According to some embodiments of the present disclosure, the audio rendering system may include an audio information processing module, which is configured to acquire an audio parameter of an audio signal of a specific type based on an audio content format of the audio signal of the specific type, and in particular, acquire the audio parameter based on the audio content format of the audio signal having the audio content format compatible with the audio rendering system that is derived from the input audio signal. For example, the audio parameter may be a parameter of a specific type corresponding to the audio content format, as described above. In some embodiments, for example, the audio information processing module may be configured to acquire the audio parameter of the audio signal in the specific audio content format based on the metadata associated with the audio signal in the specific audio content format, and in particular, acquire the audio parameter based on the metadata associated with the audio signal of the specific audio content format, as the metadata information available for encoding. In particular, in some embodiments, the audio information processing module may be configured to perform information extraction of the audio signal based on the audio content format of the audio signal having the audio content format compatible with the audio rendering system that is derived from the input audio signal. The audio information processing module may be included in the audio signal acquisition module, which may receive the metadata output by the pre-processing module and perform processing based on the metadata.

According to some embodiments of the present disclosure, the audio signal is an object-based audio representation signal, and the audio information processing module is configured to acquire spatial location information of the object-based audio representation signal as an audio parameter available for spatial audio encoding processing, for example, acquire the spatial location information of the audio signal from metadata information associated with the object-based audio representation signal. In some embodiments, the spatial location information of the audio signal includes location information of each audio element in a coordinate system, or relative location information of a sound source related to the audio signal relative to a listener. In some embodiments, the spatial location information of the audio signal further includes distance information of each sound element of the audio signal in the coordinate system. As an example, in the metadata processing of the object-based audio representation, the location information (for example, azimuth and elevation) of each sound element in the coordinate system may be acquired, and optionally, distance information may also be acquired, or the relative location information of each sound source relative to the listener's head may be acquired.

According to some embodiments of the present disclosure, the audio signal is a scene-based audio representation signal, and the audio information processing module is configured to acquire rotation information related to the audio signal from the metadata associated with the audio signal for spatial audio encoding processing. In some embodiments, the rotation information related to the audio signal includes at least one of rotation information of the audio signal, or rotation information of the listener of the audio signal. As an example, in the metadata processing of the scene-based audio representation, the rotation information of the scene audio and the rotation information of the listener can be read from the metadata.

According to some embodiments of the present disclosure, the audio signal is a channel-based audio signal, and the audio information processing module is configured to acquire the audio parameter based on a channel audio track type of the audio signal. In particular, the audio encoding processing is mainly for a specific type of channel-based audio signal that needs to be spatially encoded, especially the narrative channel audio track of the channel-based audio signal, and the audio information processing module may be configured to perform at least one of the following: dividing the channel-based audio representation into audio elements by channel and then convert them into metadata as the audio parameter, or directly outputting the audio signal without performing spatial audio processing. In yet another embodiment, for a non-narrative channel audio track, the audio information processing module is configured to directly output the audio signal without performing spatial audio processing. It should be pointed out that, for example, depending on the specific application scenario, a narrative channel audio track of the channel-based audio signal may not need to be subjected to spatial audio encoding, and such an audio track may be directly transmitted to a decoding stage or further processed depending on the playback manner.

As an example, in the metadata processing of the channel-based audio representation, for the narrative channel audio track, according to the standard definition of the channel, the audio representation of the channel may be divided into audio elements by channel and then be converted into metadata for processing. Depending on requirements of the application scenario, spatial audio processing may not be performed, and mixing is performed for different playback manners in the subsequent section. For the non-narrative channel audio track, since dynamic spatialization processing is not required, mixing may be performed for different playback manners in the subsequent section. That is to say, the non-narrative channel audio track will not be processed by the audio information processing module, that is, will not be subjected to spatial audio processing, but may be directly transmitted/passed through, while bypassing the audio information processing module.

According to embodiments of the present disclosure, the audio information processing module may be referred to as a scene information processing module/processor, and the audio parameter acquired by the audio information processing module may be input to the audio signal encoding module. Accordingly, the audio signal encoding module may be further configured to spatially encode the audio signal in the specific audio content format based on the audio parameter. Here, the audio signal in the specific audio content format may include the audio signal having the audio content format compatible with the audio rendering system that is derived from the input audio signal, for example, at least one of the scene-based audio representation signal, the object-based audio representation signal, or the channel-based audio representation signal as described above, and more particularly, for example, at least one of the object-based audio representation signal, the scene-based audio representation signal, or a specific type of channel signal in the channel-based audio representation signal. As an example, the specific type of channel signal may be referred to as a first specific type of channel signal, which may include a non-narrative channel/audio track in the channel-based audio representation signal. In another example, the specific type of channel signal may further include a narrative channel/audio track that does not need to be spatially encoded according to the application scenario.

### Audio Signal Processing

For the acquired audio signal, such as the input audio signal or the audio signal having the specific spatial format, processing, such as spatial audio processing, may be further performed on the audio signal to obtain an audio signal having a specific spatial audio exchange format.

In some embodiments, the audio signal spatial encoder may perform appropriate encoding processing on the non-directly transmitted/passed audio signal to obtain the encoded audio signal in the specific spatial format that may be used for playback in the user application scenario. The encoded audio signal in the specific spatial format may be the audio signal in the specific spatial format as described above, which will not be described in detail here. The encoded audio signal may be added to the intermediate signal, or may be directly transmitted/passed through to the spatial decoder. As an example, in the spatial encoding module, all audio signals except the non-narrative channel are converted into FOA, HOA or MOA signals through spatial encoding and used as the intermediate signal.

In some embodiments, the audio signal spatial encoder may appropriately encode audio signals in different audio content formats. The audio signals in different audio content formats may be directly input, or may be extracted/parsed from the input audio signal, for example, obtained through the pre-processing module as described above.

As an example, in the case where the input audio signal contains the audio signal having the spatial audio exchange format that is distributed to the audio rendering system, the spatial audio processing may be performed on the input audio signal to obtain the audio signal in the specific spatial format. In particular, the spatial audio exchange format may be any known appropriate format of the audio signal in signal transmission, such as an audio distribution format in audio signal distribution as described above, which will not be described in detail here. As another example, the spatial audio processing may include at least one of parsing, format transformation, information processing, encoding, etc., performed on the input audio signal. In particular, the audio signal in each audio content format may be obtained from the input audio signal through audio parsing, and then the parsed signal is encoded to obtain the audio signal in a spatial format suitable for rendering in the user application scenario, that is, the playback environment, for playback. In addition, optionally, format conversion and signal information processing may also be performed before encoding. Therefore, the audio signal having the specific spatial audio representation manner may be obtained from the input audio signal, and the audio signal in the specific spatial format may be obtained based on the audio signal having the specific spatial audio representation manner.

As an example, further, for the obtained audio signal having the specific audio representation, the audio processing may be performed based on the audio representation manner of the audio signal. Specifically, the spatial audio encoding is performed on at least one of the scene-based audio representation signals, the object-based audio representation signal, or the narrative channel in the channel-based audio representation signal to obtain the audio signal having the specific spatial format. That is to say, although the formats/representation manners of the input audio signals may be different, the input audio signals may still be converted into the common audio signal having the specific spatial format for decoding and rendering. The spatial audio encoding processing may be performed based on the metadata related information associated with the audio signal. The metadata related information here may include metadata of the audio signal that is directly acquired, for example, obtained from the input audio signal during the parsing process, and/or optionally, may further include the audio parameter corresponding to the spatial audio signal acquired by performing information processing on the acquired metadata information of each signal, and the spatial audio encoding processing may be performed based on the audio parameter.

In some embodiments, the audio signal in the specific audio content format is the object-based audio representation signal, and the audio signal spatial encoder is configured to spatially encode the object-based audio signal based on information related to a spatial propagation path from the sound object in the audio signal to the listener. In some embodiments, the information related to the spatial propagation path from the sound object to the listener includes at least one of propagation duration, propagation distance, location information, path intensity energy, and nodes along the path of each spatial propagation path from the sound object to the listener. In some embodiments, the audio signal spatial encoder is configured to, for each spatial propagation path of each sound object, perform the audio signal spatial encoding according to a filtering function that is used for filtering the audio signal based on the path energy intensity of the spatial propagation path and a spherical harmonic function that is based on the azimuth angle of the spatial propagation path. In some embodiments, the audio signal spatial encoder is configured to, for each spatial propagation path of each sound object, calculate a product of the filtering function that is used for filtering the audio signal based on the path energy intensity of the spatial propagation path and the spherical harmonic function that is based on the position angle of the spatial propagation path to perform the audio signal spatial encoding. In some embodiments, for each spatial propagation path of each sound object, the filtering function that is used for filtering the audio signal based on the path energy intensity is a filtering function for filtering the audio signal of the sound object before propagating along the spatial propagation path based on the path intensity energy of the path. In some embodiments, the audio signal of the sound object before propagating along the spatial propagation path refers to an audio signal at a time moment before a time required for the sound object to reach the listener along the spatial propagation path. In some embodiments, the azimuth angle of the spatial propagation path includes a direction angle at which the spatial propagation path reaches the listener or a direction angle of the spatial propagation path relative to a coordinate system. In some embodiments, the audio signal spatial encoder is configured to, for each spatial propagation path of each sound object, further perform encoding according to the length of the spatial propagation path using at least one of a near-field compensation function or a spreading function. For example, the near-field compensation function and/or the spreading function may be further applied on the basis of the encoded HOA signal as described above. In particular, it may be considered to apply the near-field compensation function if the distance of the path is less than a threshold, and apply the spreading function if the distance of the path is greater than the threshold, and vice versa, to further optimize the encoded HOA signal as described above. In some embodiments, the audio signal spatial encoder is further configured to perform weighted superposition on the encoded signal of each object-based audio representation signal based on the weight of the sound object defined in the metadata.

As an example, in the spatial encoding processing of the object-based audio representation, for each audio object, considering the delay of sound propagation in space, the audio signal is written into a delayer. According to the result obtained by the audio information processing module, each sound object may have one or more propagation paths to the listener, and the time t1 required for the sound object to reach the listener is calculated according to the length of each path. The spatial encoding starts from acquiring the audio signal s of the sound object before the time t1 from the delayer of the audio object, performing filtering E according to the path energy intensity, and according to the direction θ of the path reaching the listener (optionally, instead of the direction to the listener, the direction of the path relative to the coordinate system may also be used, so that the target sound field signal may be obtained by multiplying by the rotation matrix in the subsequent step), and spatially encoding and converting the signal into an HOA signal s_{N}, where N is the number of channels of the HOA signal. A typical encoding method is as follows, where Y_N means a spherical harmonics function for a corresponding channel.

$${s}_{N} = E ( s ( t - {t}_{1} ) ) {Y}_{N} ( θ )$$

The encoding operation may be performed in the time domain or the frequency domain, and the near-field compensation function and the source spread function may also be added according to the distance of the path to enhance the effect. Finally, the HOA signals obtained after each signal conversion are weighted and superimposed according to the weight for the sound object defined in the metadata, so that the weighted sum signal of all object-based audio signals may be obtained as the encoded signal, which may be used as the intermediate signal.

In some embodiments, the audio signal spatial encoding may also generate a reverberation related signal to be included in the output encoded signal. In particular, the reverberation related signal may be directly transmitted to the spatial decoder for decoding, or may be added to the intermediate signal containing the encoder output.

In some embodiments, the audio signal in the specific audio content format is the object-based audio representation signal, and the audio signal spatial encoder is further configured to obtain a reverberation related signal of the object-based audio signal. In some embodiments, the audio signal spatial encoder is further configured to acquire a spatial reverberation response of the scene, and perform convolution of the audio signal based on the spatial reverberation response to obtain the reverberation related signal of the audio signal. In some embodiments, the audio signal spatial encoder is further configured to acquire reverberation parameter information, and perform reverberation processing on the audio signal to obtain the reverberation related signal of the audio signal. As an example, for an advanced scene information processor, a spatial room reverberation response of the scene may be generated, including but not limited to RIR (Room Impulse Response), ARIR (Ambisonics Room Impulse Response), BRIR (Binaural Room Impulse Response), and MO-BRIR (Multi orientation Binaural Room Impulse Response). For such information, a convolver may be added in this module to obtain the processed signal. Depending on the reverberation type, the generated result may be an intermediate signal (ARIR), an omnidirectional signal (RIR) or a binaural signal (BRIR, MO-BRIR), and the output result can be added to the intermediate signal or passed through to the next step for corresponding playback decoding processing. Optionally, the scene information processor may also provide reverberation parameter information such as reverberation duration, and an artificial reverberation generator (such as a feedback delay network) may be added in this module to perform artificial reverberation processing, and the result is output to the intermediate signal or passed through to the decoder for processing.

In some embodiments, the audio signal in the specific audio content format is the scene-based audio representation signal, and the audio signal spatial encoder is further configured to weight the scene-based audio representation signal based on weight information in the metadata. In this way, the weighted signal may be used as the encoded audio signal for spatial decoding. In some embodiments, the audio signal in the specific audio content format is the scene-based audio representation signal, and the audio signal spatial encoder is further configured to perform the sound field rotation operation on the scene-based audio representation signal based on the rotation information indicated in the metadata. In this way, the rotated audio signal may be used as the encoded audio signal for spatial decoding. As an example, for the scene audio signal, which itself is an FOA, HOA or MOA signal, the weighting may be performed according to the weight information in the metadata, so as to obtain the desired intermediate signal. In addition, if the metadata prompts that the sound field needs to be rotated, the sound field rotation operation may be performed in this step or in spatial decoding (next step) according to different implementations.

In some embodiments, the audio signal in the specific audio content format is the channel-based audio representation signal, and the audio signal spatial encoder is further configured to, in the case where the channel-based audio representation signal needs to be converted, convert the channel-based audio representation signal into the object-based audio representation signal and then encode the object-based audio representation signal. The encoding operation here may be performed in the same manner as that of encoding the object-based audio representation signal as described above. As an example, in the spatial encoding processing of the channel-based audio representation, the channel-based audio processing is performed according to the agreement in the scene information processing in the previous step, and if the audio signal is required to be converted to the object-based audio, then the object-based audio processing manner is performed. If no spatial audio processing is required, the signal can be directly passed through to the next module without adding the intermediate signal.

On the other hand, the input audio signal may be in other appropriate formats other than the non-spatial audio exchange format, especially, for example, the specific spatial representation signal, or even the specific spatial format signal. In this case, at least some of the spatial audio processing described above may be skipped to obtain the audio signal in the specific spatial format. In some embodiments, in the case where the input audio signal is not the distributed audio signal having the spatial audio exchange format, but the directly input audio signal having the specific spatial audio representation, the format conversion and encoding may be directly performed, without performing the audio parsing processing as described above. Even in the case where the input audio signal has the predetermined format, the encoding processing may be directly performed, without performing the format conversion as described above. In some other embodiments, the input audio signal is directly the audio signal in the specific spatial format, and such an input audio signal may be directly transmitted/passed through to the audio signal spatial decoder, without spatial audio processing, such as parsing, format conversion, information processing, encoding, etc. For example, in the case where the input audio signal is the scene-based spatial audio representation signal, such an input audio signal may be directly used as the signal in the specific spatial format and directly transmitted to the spatial decoder, without the spatial audio processing as described above. According to some embodiments, in the case where the input audio signal is not the distributed audio signal having the spatial audio exchange format, for example, it may be the audio signal having the specific spatial audio representation or the audio signal in the specific spatial format as described above, which may be directly input at the user side/consumer side, for example, may be directly acquired from an application interface (API) directly provided in the rendering system.

For example, in the case of a signal having a specific representation manner directly input at the user side/consumer side, for example, in the case of one of the three audio representation manners as described above, the signal may be directly converted into the format specified by the system without the parsing processing as described above. For another example, in the case where the input audio signal is already in the format specified by the system and the representation manner that may be processed by the system, the input audio signal may be directly sent to the spatial encoding processing module, without the parsing and code conversion as described above. For another example, if the input audio signal is a non-narrative channel signal, a reverberated binaural signal, etc., the input audio signal may be directly transmitted to the spatial decoding module for decoding, without performing the spatial audio encoding processing as described above. In this case, a determination unit/module may exist in the system to determine whether the input audio signal satisfies the above conditions.

In some embodiments, in the case where the input audio signal is not the distributed spatial audio exchange format signal, it may not be necessary to perform at least some of the spatial audio processing on the input audio signal. As an example, the input specific audio signal may directly be at least one of the three signal representation manners as described above, so that the signal parsing processing as described above may be omitted, and the audio signal and the associated metadata may be directly sent to the audio signal encoding module. In some other embodiments, the input audio signal may even be the audio signal in the specific spatial format as described above, and such an input audio signal may be directly transmitted/passed through to the audio signal decoding module, without performing the spatial audio processing including parsing, format conversion, audio encoding, etc. as described above.

In some embodiments, for such an input audio signal, the audio rendering system may further include a specific audio input device, which is configured to directly receive the input audio signal and directly transmit/pass the input audio signal through to the audio signal encoding module or the audio signal decoding module. It should be pointed out that such a specific input device may be, for example, an application interface (API), and the format of the input audio signal that may be received by the API has been preset, for example, corresponding to the specific spatial format as described above, for example, may be at least one of the three signal representation manners as described above, etc. Thus, when the input device receives the input audio signal, the input audio signal may be directly passed through/transmitted, without at least some of the spatial audio processing. It should be pointed out that such a specific input device may also be a part of the audio signal acquisition operation/module, or even be included in the audio signal parsing module.

It should be pointed out that the implementations of the audio signal parsing module and the specific audio input device as described above are only exemplary and non-restrictive. According to some embodiments of the present disclosure, the audio signal parsing module may be implemented in various appropriate manners. In some embodiments, the audio signal parsing module may include a parsing subunit and a direct transmission subunit. The parsing subunit may only receive the audio signal in the spatial exchange format for audio parsing, and the direct transmission subunit may receive the audio signal in the specific audio content format or the specific audio representation signal for direct transmission. In this way, the audio rendering system may be configured such that the audio signal parsing module receives two channels of inputs, which are respectively the audio signal in the spatial exchange format and the audio signal in the specific audio content format or the specific audio representation signal. In some other embodiments, the audio signal parsing module may include a determination subunit, a parsing subunit and a direct transmission subunit, so that the audio signal parsing module may receive any type of input signal and perform appropriate processing. The determination subunit may determine the format/type of the input audio signal, and in the case where it is determined that the input audio signal is the audio signal in the spatial audio exchange format, the parsing subunit is instructed to perform the parsing operation as described above, otherwise, the audio signal may be directly transmitted/passed through by the direct transmission subunit to the stages of format conversion, audio encoding, audio decoding, etc., as described above. Certainly, the determination subunit may also be outside the audio signal parsing module. The audio signal determination may be implemented in various known appropriate manners, which will not be described in detail here.

### Audio Signal Spatial Decoding

Then, spatial decoding may be performed on the obtained audio signal having the specific spatial format. In particular, the obtained audio signal having the specific spatial format may be referred to as the audio signal to be decoded, and the audio signal spatial decoding aims at converting the audio signal to be decoded into a format suitable for playback through the playback device or the rendering device in the user application scenario, such as the audio playback environment, or the audio rendering environment. According to embodiments of the present disclosure, decoding may be performed according to an audio signal playback mode, and the playback mode may be indicated in various appropriate manners, for example, by an identifier, and the decoding module may be informed of the playback mode in various appropriate manners, for example, together with the input audio signal, or the playback mode may be input by another input device and informed to the decoding module. As an example, the renderer ID as described above may be used as the identifier to inform whether the playback mode is binaural playback or speaker playback, etc. In some embodiments, the audio signal decoding may use a decoding manner, especially a decoding matrix, corresponding to the playback device in the user application scenario to decode the audio signal in the specific spatial format, to transform the audio signal to be decoded into audio of a suitable format. In some other embodiments, the audio signal decoding may also be performed by other appropriate means, such as virtual signal decoding.

In some embodiments, the audio signal spatial decoder uses the decoding matrix corresponding to the playback device in the user application scenario to decode the audio signal in the specific spatial format. In this way, the decoded audio signal may be suitable for a specific type of playback environment, especially for the playback device in the playback environment, thereby achieving compatibility with various types of playback environments. Here, the audio signal in the specific spatial format may be the intermediate signal as described above, or may be an audio signal directly transmitted/passed through to the spatial decoder, including the unencoded audio signal, or the encoded audio signal that has been spatially encoded but is not included in the intermediate signal. In particular, after the encoding processing of the spatial audio signal, the system obtains the spatially encoded intermediate medium signal and the pass-through signal, such as, non-narrative channel signal and reverberated binaural signal. The spatial audio decoding module decodes the intermediate signal and the pass-through signal to the playback device according to the playback type of the user application scenario.

In some embodiments, the audio signal spatial decoder is configured to perform the sound field rotation operation on the audio representation signal to be decoded based on the rotation information indicated in the metadata. As an example, first, according to the processing method of the previous module and the rotation information in the metadata, the intermediate medium signal can be multiplied by the rotation matrix as needed to obtain the rotated intermediate medium signal, so that the rotated intermediate medium signal may be decoded.

In some embodiments, the decoding matrix is a built-in decoding matrix or a decoding matrix that is provided from the outside and that corresponds to the speaker array in the user application scenario.

As an example, in the case of spatial decoding for a standard speaker array, the standard speaker array defined in the standard is, for example, 5.1. The decoder may have built-in decoding matrix coefficients, and the playback signal L may be obtained by multiplying the intermediate signal by the decoding matrix. L=DS_{N}, where L is the speaker array signal, D is the decoding matrix, and S_{N} is the intermediate signal. At the same time, according to the definition of the standard speaker, the pass-through signal may be converted into the speaker array, by specific means, such as VBAP, etc. In the case of spatial decoding for a specific speaker array, for a sound bar or some more specific speaker arrays, the speaker manufacturer may be required to provide a correspondingly designed decoding matrix. The system provides a decoding matrix setting interface to perform decoding processing by formulating the decoding matrix.

In some embodiments, in the case where the speaker array is a customized speaker array, the decoding matrix is a decoding matrix calculated according to an arrangement of the customized speaker array. In some embodiments, the decoding matrix is calculated according to an azimuth and an elevation angle of each speaker in the speaker array or three-dimensional coordinate values of the speaker. As an example, in the spatial decoding for the customized speaker array, in the scenario of the customized speaker array, such speakers usually have a spherical, semi-spherical or a rectangular design, which may surround or semi-surround the listener. The decoding module may calculate the decoding matrix according to the arrangement of the customized speakers, which requires the input of the azimuth and elevation angle of each speaker, or the three-dimensional coordinate values of the speaker. The calculation methods of the speaker decoding matrix may include SAD (Sampling Ambisonic Decoder), MMD (Mode Matching Decoder), EPAD (Energy preserved Ambisonic Decoder), AllRAD (All Round Ambisonic Decoder), etc.

In some embodiments, in the case where the user application environment is a headphone playback environment, the audio signal spatial decoder is configured to directly decode the signal into a binaural signal, or perform speaker virtualization to obtain the decoded signal. As an example, for the playback environment of the headphone, there are several optional decoding manners. The first one is to directly decode the intermediate medium signal into the binaural signal, and typical methods include LS (least squares), Magnitude LS, SPR (Spatial resampling), etc. The pass-through signal, which is usually a binaural signal, is directly played back. Indirect rendering may also be performed, that is, a speaker array is used first, and then HRTF convolution is performed according to the location of the speaker to perform virtualization processing of the speaker.

According to some embodiments of the present disclosure, optionally, after the audio signal decoding, post-processing may be performed on the decoded output, especially signal adjustment, for adjusting the spatially decoded audio signal, especially adjusting the audio signal characteristic, for a specific playback device in the user application scenario, so that a more appropriate acoustic experience can be presented when the adjusted audio signal is rendered by the audio rendering device.

### Audio Signal Post-Processing

According to embodiments of the present disclosure, optionally or additionally, the spatially decoded audio signal may be adjusted for a specific playback device in the user application scenario, so that a more appropriate acoustic experience is presented when the adjusted audio signal is rendered by the audio rendering device. In particular, the audio signal adjustment may mainly aim at eliminating the possible inconsistency between different playback types or different playback manners, etc., so that when the adjusted audio signal is played back in the application scenario, a consistent playback experience can be maintained, the user experience can be improved. In the context of the present disclosure, the audio signal adjustment processing may be referred to as a kind of post-processing, which refers to post-processing on the output signal obtained through audio decoding, and it may be referred to as output signal post-processing. In some embodiments, the signal post-processing module is configured to perform at least one of frequency response compensation or dynamic range control on the decoded audio signal for the specific playback device.

In some embodiments, the audio processing system may further include a signal post-processing module, which may be configured to perform at least one of frequency response compensation or dynamic range control on the decoded audio signal for a specific playback device. As an example, considering the inconsistency among different playback manners and different playback devices having different frequency response curves and gains, in order to present a consistent acoustic experience, the post-processing module is configured to post-process and adjust the output signal. Post-processing operations include, but not limited to, frequency response compensation (EQ, Equalization) and dynamic range control (DRC, Dynamic range control) for specific devices.

In the audio rendering system of the present disclosure, the audio information processing module, the audio signal spatial encoder, the audio signal spatial decoder and the output signal post-processing as described above may constitute a core rendering module of the system, which is responsible for processing the signals in the three audio representation formats obtained after the pre-processing and their metadata, and playing them back through the playback device in the user application environment.

It should be pointed out that the processing of the audio data and/or the metadata in the rendering processing as described above may be performed in various appropriate forms. According to some embodiments, the audio signal processing may be performed in units of blocks, and the block size may be set. For example, the block size may be preset and not changed during the processing. For example, the block size may be set during the initialization of the audio rendering system. In some embodiments, the metadata may be parsed in units of blocks, and then the scene information may be adjusted for the metadata. This operation may be included in the operation of the scene information processing module according to the embodiments of the present disclosure.

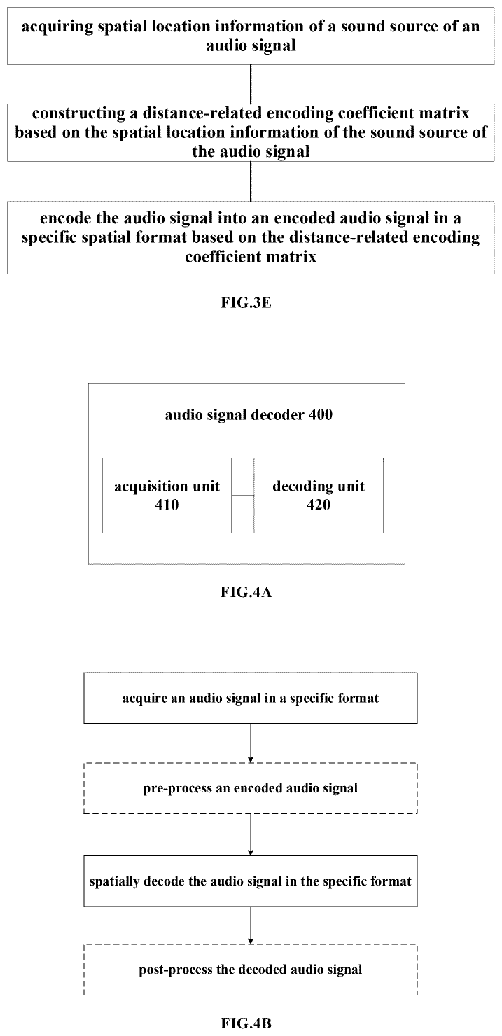

FIG. 5 shows a block diagram of some embodiments of an electronic device according to the present disclosure.

As shown in FIG. 5, the electronic device 5 in this embodiment includes: a memory 51 and a processor 52 coupled to the memory 51, where the processor 52 is configured to, based on instructions stored in the memory 51, execute the reverberation duration estimation method or the audio signal rendering method in any one of the embodiments of the present disclosure.

The memory 51 may include, for example, a system memory, a fixed non-volatile storage medium, etc. The system memory stores, for example, an operating system, an application, a boot loader, a database, and other programs.

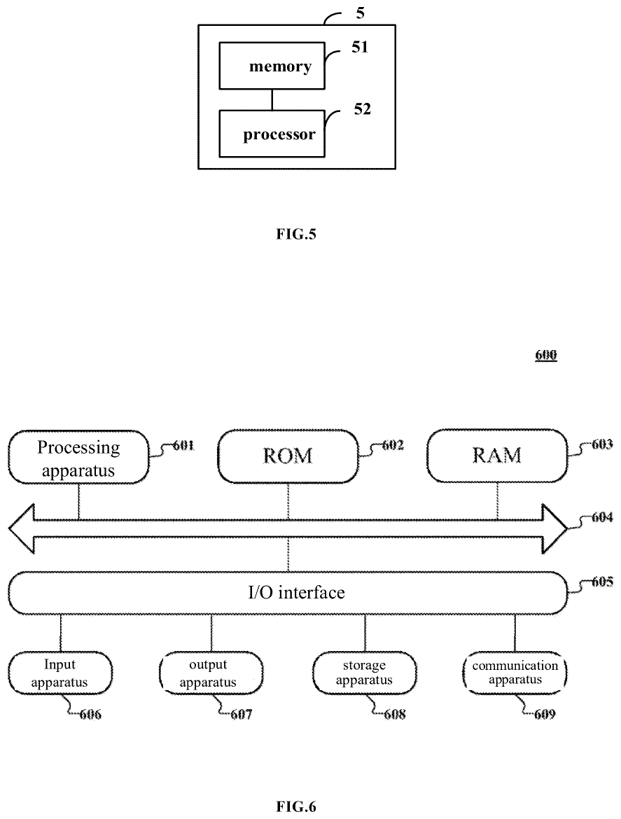

Reference is made to FIG. 6 below, which shows a schematic structural diagram of an electronic device suitable for implementing the embodiments of the present disclosure. The electronic device in the embodiments of the present disclosure may include, but is not limited to, mobile terminals such as a mobile phone, a notebook computer, a digital broadcast receiver, a personal digital assistant (PDA), a tablet computer, a portable media player (PMP), an in-vehicle terminal (e.g., an in-vehicle navigation terminal), etc., and fixed terminals such as a digital TV, a desktop computer, etc. The electronic device shown in FIG. 6 is only an example, and should not impose any limitation on the function and scope of use of the embodiments of the present disclosure.

FIG. 6 shows a block diagram of some other embodiments of an electronic device according to the present disclosure.

As shown in FIG. 6, the electronic device may include a processing apparatus (e.g., a central processing unit, a graphics processing unit, etc.) 601 that may perform various appropriate actions and processing according to a program stored in a read-only memory (ROM) 602 or a program loaded from a storage apparatus 608 into a random-access memory (RAM) 603. The RAM 603 further stores various programs and data required for operations of the electronic device. The processing apparatus 601, the ROM 602, and the RAM 603 are interconnected by means of a bus 604. An input/output (I/O) interface 605 is also connected to the bus 604.

Typically, the following apparatuses may be connected to the I/O interface 605: an input apparatus 606 including, for example, a touch screen, a touchpad, a keyboard, a mouse, an image sensor, a microphone, an accelerometer, a gyroscope, etc.; an output apparatus 607 including, for example, a liquid crystal display (LCD), a speaker, a vibrator, etc.; the storage apparatus 608 including, for example, a magnetic tape, a hard disk, etc.; and a communication apparatus 609. The communication apparatus 609 may allow the electronic device to be in wireless or wired communication with other devices to exchange data. Although FIG. 6 shows the electronic device having various apparatuses, it should be understood that not all the apparatuses shown here need to be implemented or provided. Alternatively, more or fewer apparatuses may be implemented or provided.

According to the embodiments of the present disclosure, the process described above with reference to the flowchart may be implemented as a computer software program. For example, the embodiments of the present disclosure include a computer program product including a computer program carried on a computer-readable medium, where the computer program contains program code for performing the method shown in the flowchart. In such an embodiment, the computer program may be downloaded and installed from a network via the communication apparatus 609, or installed from the storage apparatus 608, or installed from the ROM 602. When the computer program is executed by the processing apparatus 601, the functions defined in the method of the embodiments of the present disclosure are executed.

In some embodiments, there is further provided a chip, including: at least one processor and an interface, where the interface is configured to provide computer-executable instructions for the at least one processor, and the at least one processor is configured to execute the computer-executable instructions to implement the reverberation duration estimation method, or the audio signal rendering method of any one of the embodiments described above.

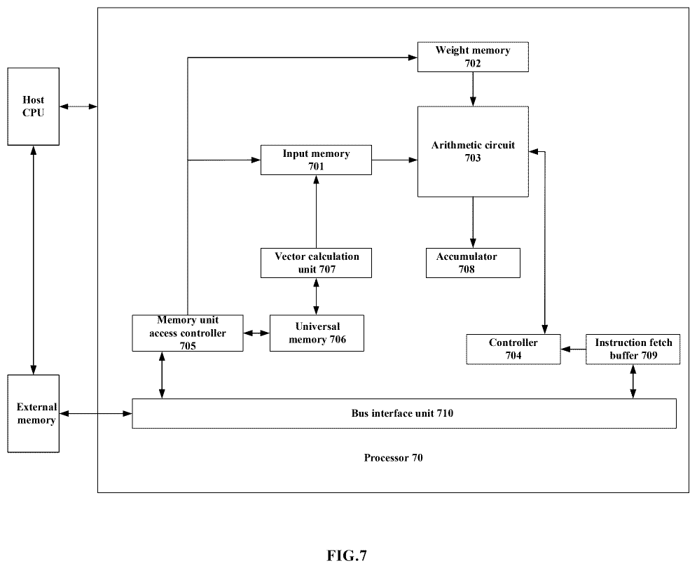

FIG. 7 shows a block diagram of some embodiments of a chip according to the present disclosure.

As shown in FIG. 7, the processor 70 of the chip is mounted on a main CPU (Host CPU) as a coprocessor, and tasks are allocated by the Host CPU. The core of the processor 70 is an operation circuit, and the controller 704 controls the operation circuit 703 to extract data from a memory (a weight memory or an input memory) and perform operations.

In some embodiments, the operation circuit 703 includes a plurality of processing units (Process Engine, PE). In some embodiments, the operation circuit 703 is a two-dimensional systolic array. The operation circuit 703 may also be a one-dimensional systolic array or other electronic circuits that may perform mathematical operations such as multiplication and addition. In some embodiments, the operation circuit 703 is a general-purpose matrix processor.

For example, it is assumed that there are an input matrix A, a weight matrix B, and an output matrix C. The operation circuit fetches data corresponding to the matrix B from the weight memory 702 and buffers the data on each PE in the operation circuit. The operation circuit obtains data of the matrix A from the input memory 701 and performs a matrix operation on the data of the matrix A and the data of the matrix B, and a partial result or a final result of the obtained matrix is stored in an accumulator 708.

The vector calculation unit 707 may further process the output of the operation circuit, such as vector multiplication, vector addition, an exponential operation, a logarithm operation, size comparison, etc.

In some embodiments, the vector calculation unit 707 may store a processed output vector in a unified buffer 706. For example, the vector calculation unit 707 may apply a nonlinear function to the output of the operation circuit 703, such as a vector of accumulation values, to generate activation values. In some embodiments, the vector calculation unit 707 generates normalized values, merged values, or both. In some embodiments, the processed output vector may be used as an activation input to the operation circuit 703, for example, for use in a subsequent layer in the neural network.

The unified memory 706 is used for storing input data and output data.

A memory access controller 705 (Direct Memory Access Controller, DMAC) moves input data in an external memory to the input memory 701 and/or the unified memory 706, stores weight data in the external memory into the weight memory 702, and stores data in the unified memory 706 into the external memory.

A bus interface unit (Bus Interface Unit, BIU) 510 is configured to implement interaction among the main CPU, the DMAC, and the instruction fetch buffer 709 through a bus.

An instruction fetch buffer 709 connected to the controller 704 is configured to store an instruction used by the controller 704;
the controller 704 is configured to call the instruction cached in the instruction fetch buffer 709 to control a working process of the operation accelerator.

Generally, the unified memory 706, the input memory 701, the weight memory 702, and the instruction fetch buffer 709 are all on-chip memories, and the external memory is a memory external to the NPU, and the external memory may be a double data rate synchronous dynamic random access memory (Double Data Rate Synchronous Dynamic Random Access Memory, DDR SDRAM), a high bandwidth memory (High Bandwidth Memory, HBM), or other readable and writable memories.

In some embodiments, there is further provided a computer program, including: instructions that, when executed by a processor, cause the processor to execute the audio signal rendering method, the audio signal encoding method, etc. of any one of the embodiments described above.

It should be understood by those skilled in the art that the present disclosure may be implemented in the form of a complete hardware embodiment, a complete software embodiment, or an embodiment combining software and hardware. When software is used to implement the present disclosure, the embodiments described above may be implemented entirely or partially in the form of a computer program product. The computer program product includes one or more computer instructions or computer programs. When the computer instructions or the computer program are loaded or executed on a computer, the procedure or functions according to the embodiments of the present application are entirely or partially generated. The computer may be a general-purpose computer, a dedicated computer, a computer network, or other programmable apparatuses. Moreover, the present disclosure may be implemented in the form of a computer program product implemented on one or more computer-usable non-transitory storage media (including but not limited to a magnetic disk memory, a CD-ROM, an optical memory, etc.) having computer-usable program code embodied therein.

Although some specific embodiments of the present disclosure have been described in detail by way of examples, those skilled in the art should understand that the above examples are only for illustration, and are not intended to limit the scope of the present disclosure. Those skilled in the art should understand that the embodiments described above may be modified without departing from the scope and spirit of the present disclosure. The scope of the present disclosure is defined by the appended claims.

What is claimed is:

1. An audio signal encoding method for audio rendering, comprising:
acquiring metadata related information associated with an audio signal, the metadata related information comprising spatial location information related to the audio signal; and
spatially encoding the audio signal based on the metadata related information associated with the audio signal to obtain an encoded audio signal.

2. The audio signal encoding method of claim 1, wherein spatially encoding the audio signal to obtain the encoded audio signal comprises:
determining an encoding parameter based on the metadata related information; and
encoding the audio signal into an encoded audio signal in a specific spatial format based on the encoding parameter.

3. The audio signal encoding method of claim 2, wherein, determining the encoding parameter based on the metadata related information comprises at least one of:
in response to that the spatial location information related to the audio signal comprises distance information of a sound source of the audio signal, determining an encoding coefficient matrix based on the distance information of the sound source of the audio signal as the encoding parameter,
in response to that the metadata related information further comprises directional information of a sound source of the audio signal, determining an encoding coefficient matrix based on the directional information of the sound source of the audio signal as the encoding parameter, or
determining a corresponding encoding coefficient matrix for a channel of the audio signal in the specific spatial format to be encoded as the encoding parameter, and
wherein, encoding the audio signal into the encoded audio signal in the specific spatial format based on the encoding parameter further comprises:
performing encoding by multiplying or convolving the audio signal with the encoding matrix.

4. The audio signal encoding method of claim 2, wherein determining the encoding parameter based on the metadata related information further comprises: determining the encoding parameter based on a combination of spatial location information of a sound source and reference spatial location information.

5. The audio signal encoding method of claim 4, wherein the spatial location information of the sound source comprises a distance of the sound source, the reference spatial location comprises a reference distance, and the combination of the spatial location information of the sound source and the reference spatial location comprises a ratio between the distance of the sound source and the reference distance, and
determining the encoding parameter based on the combination of the spatial location information of the sound source and the specific reference spatial location further comprises:
constructing a distance-related encoding coefficient matrix based on the ratio between the distance of the sound source and the reference distance.

6. The audio signal encoding method of claim 2, wherein the audio signal encoding is performed by solving an acoustic equation constructed for the audio signal, and
determining the encoding parameter based on the metadata related information further comprises:
determining the encoding parameter by solving, based on a specific function, a sub-equation related to distance information of a sound source that is comprised in or is derivable from the acoustic equation.

7. The audio signal encoding method of claim 1, wherein the audio signal encoding is performed based on solving an acoustic equation constructed for the audio signal, and
the method further comprises: applying a specific filtering to the solving of the acoustic equation,
wherein the filtering comprises at least one of HIR filtering and FIR filtering,
wherein the HIR filtering is constructed by performing spectrum fitting by using a least square method based on frequency information in a digital domain; and the FIR filtering is obtained by performing time-frequency transformation to acquire zero point and pole point characteristics and then using bilinear transformation.

8. An electronic device, comprising:
a memory; and
a processor coupled to the memory, the processor is configured to, based on instructions stored in the memory, implement:
acquiring metadata related information associated with an audio signal, the metadata related information comprising spatial location information related to the audio signal; and
spatially encoding the audio signal based on the metadata related information associated with the audio signal to obtain an encoded audio signal.

9. The electronic device of claim 8, wherein spatially encoding the audio signal to obtain the encoded audio signal comprises:
determining an encoding parameter based on the metadata related information; and
encoding the audio signal into an encoded audio signal in a specific spatial format based on the encoding parameter.

10. The electronic device of claim 9, wherein, determining the encoding parameter based on the metadata related information comprises at least one of:
in response to that the spatial location information related to the audio signal comprises distance information of a sound source of the audio signal, determining an encoding coefficient matrix based on the distance information of the sound source of the audio signal as the encoding parameter,
in response to that the metadata related information further comprises directional information of a sound source of the audio signal, determining an encoding coefficient matrix based on the directional information of the sound source of the audio signal as the encoding parameter, or
determining a corresponding encoding coefficient matrix for a channel of the audio signal in the specific spatial format to be encoded as the encoding parameter, and
wherein, encoding the audio signal into the encoded audio signal in the specific spatial format based on the encoding parameter further comprises:
performing encoding by multiplying or convolving the audio signal with the encoding matrix.

11. The electronic device of claim 9, wherein determining the encoding parameter based on the metadata related information further comprises: determining the encoding parameter based on a combination of spatial location information of a sound source and reference spatial location information.

12. The electronic device of claim 11, wherein the spatial location information of the sound source comprises a distance of the sound source, the reference spatial location comprises a reference distance, and the combination of the spatial location information of the sound source and the reference spatial location comprises a ratio between the distance of the sound source and the reference distance, and
determining the encoding parameter based on the combination of the spatial location information of the sound source and the specific reference spatial location further comprises:
constructing a distance-related encoding coefficient matrix based on the ratio between the distance of the sound source and the reference distance.

13. The electronic device of claim 9, wherein the audio signal encoding is performed by solving an acoustic equation constructed for the audio signal, and
determining the encoding parameter based on the metadata related information further comprises:
determining the encoding parameter by solving, based on a specific function, a sub-equation related to distance information of a sound source that is comprised in or is derivable from the acoustic equation.

14. The electronic device of claim 8, wherein the audio signal encoding is performed based on solving an acoustic equation constructed for the audio signal, and
wherein the processor is configured to, based on instructions stored in the memory, further implement: applying a specific filtering to the solving of the acoustic equation,
wherein the filtering comprises at least one of HIR filtering and FIR filtering,
wherein the HIR filtering is constructed by performing spectrum fitting by using a least square method based on frequency information in a digital domain; and the FIR filtering is obtained by performing time-frequency transformation to acquire zero point and pole point characteristics and then using bilinear transformation.

15. A non-transitory computer-readable storage medium having a computer program stored thereon, wherein the program, when executed by a processor, causes the processor to implement:
acquiring metadata related information associated with an audio signal, the metadata related information comprising spatial location information related to the audio signal; and
spatially encoding the audio signal based on the metadata related information associated with the audio signal to obtain an encoded audio signal.

16. The non-transitory computer-readable storage medium of claim 15, wherein spatially encoding the audio signal to obtain the encoded audio signal comprises:
determining an encoding parameter based on the metadata related information; and
encoding the audio signal into an encoded audio signal in a specific spatial format based on the encoding parameter.

17. The non-transitory computer-readable storage medium of claim 16, wherein, determining the encoding parameter based on the metadata related information comprises at least one of:
in response to that the spatial location information related to the audio signal comprises distance information of a sound source of the audio signal, determining an encoding coefficient matrix based on the distance information of the sound source of the audio signal as the encoding parameter,
in response to that the metadata related information further comprises directional information of a sound source of the audio signal, determining an encoding coefficient matrix based on the directional information of the sound source of the audio signal as the encoding parameter, or
determining a corresponding encoding coefficient matrix for a channel of the audio signal in the specific spatial format to be encoded as the encoding parameter, and
wherein, encoding the audio signal into the encoded audio signal in the specific spatial format based on the encoding parameter further comprises:
performing encoding by multiplying or convolving the audio signal with the encoding matrix.

18. The non-transitory computer-readable storage medium of claim 16, wherein the spatial location information of the sound source comprises a distance of the sound source, the reference spatial location comprises a reference distance, and the combination of the spatial location information of the sound source and the reference spatial location comprises a ratio between the distance of the sound source and the reference distance, and
determining the encoding parameter based on the combination of the spatial location information of the sound source and the specific reference spatial location further comprises:
constructing a distance-related encoding coefficient matrix based on the ratio between the distance of the sound source and the reference distance.

19. The non-transitory computer-readable storage medium of claim 16, wherein the audio signal encoding is performed by solving an acoustic equation constructed for the audio signal, and
determining the encoding parameter based on the metadata related information further comprises:
determining the encoding parameter by solving, based on a specific function, a sub-equation related to distance information of a sound source that is comprised in or is derivable from the acoustic equation.

20. The non-transitory computer-readable storage medium of claim 15, wherein the audio signal encoding is performed based on solving an acoustic equation constructed for the audio signal, and
wherein the program, when executed by a processor, causes the processor to further implement: applying a specific filtering to the solving of the acoustic equation,
wherein the filtering comprises at least one of HIR filtering and FIR filtering,
wherein the HIR filtering is constructed by performing spectrum fitting by using a least square method based on frequency information in a digital domain; and the FIR filtering is obtained by performing time-frequency transformation to acquire zero point and pole point characteristics and then using bilinear transformation.
